(19) United States
(12) Patent Application Publication
(10) Pub. No.: US 2023/0226591 A1
(43) Pub. Date: Jul. 20, 2023

(54) VEHICLE FRAME COMPONENTS

(71) Applicant: ZIETA PROZESSDESIGN SPOLKA Z OGRANICZONA ODPOWIEDZIALNOSCIA, Wroclaw (PL)

(72) Inventor: Oskar Zieta, Wroclaw (PL)

(21) Appl. No.: 18/127,392

(22) Filed: Mar. 28, 2023

Related U.S. Application Data
(63) Continuation-in-part of application No. PCT/IB2021/059033, filed on Oct. 1, 2021.

(30) Foreign Application Priority Data
Oct. 2, 2020 (PL) P.435561
Dec. 30, 2020 (PL) P.436548
Aug. 20, 2021 (PL) P.438785

(51) Int. Cl. B21D 53/88; B21D 26/033

(52) U.S. Cl. CPC B21D 53/88; B21D 26/033

(57) ABSTRACT

Exemplary vehicle structures include a frame component that provides greater strength and/or other desired properties to a vehicle structure. The frame component includes a first wall (6) and a second wall (7). The first and second walls each comprise at least one metal sheet. The first and second walls bound a sealed interior gap (28). Pressurized fluid is introduced into the sealed interior gap through at least one of the walls via a fluid connector (8). In some arrangements the gap includes a hermetically sealed pocket (110) that is bounded by a pocket wall (36). The pressurized fluid is delivered into the pocket interior area that is bounded by the pocket wall. The fluid delivered to the sealed interior gap and/or the pocket interior area may be operative to cause controlled permanent deformation thereof to produce desired wall configurations which have increased strength. The fluid housed within the sealed interior gap may provide increased strength or other desired properties. Vehicle structures such as vehicle side frames, vehicle floor members and vehicle frame longitudinal members may each include one or more of the frame components integrated in the vehicle structure.

### TECHNICAL FIELD

Exemplary arrangements relate to vehicle frame components. Exemplary arrangements further relate to vehicle frame components that have increased strength and lower weight. Exemplary arrangements further relate to methods of making vehicle frame components.

### BACKGROUND

Vehicles include frame components that provide rigidity to vehicle structures, such as the structures of motor vehicles. Vehicle structures provide load bearing capabilities during normal vehicle operation. Vehicle structures further provide rigidity as well as energy absorbing capabilities that protect occupants of the vehicle during a collision.

Vehicle frame components of vehicle structures may have many different configurations to accommodate the needs of different types of vehicles. These include vehicles propelled by internal combustion engines, electric motors and other types of propulsion systems. It is often desirable for vehicle frame components to be lighter in weight to provide greater energy efficiency.

Numerous different types of vehicle frame components and vehicle structures have been developed. However vehicle frame components and vehicle structures and the methods of making such structures may benefit from improvements.

### SUMMARY

Exemplary arrangements relate to frame components configured to be integrated in a vehicle body structure, and methods of manufacture thereof. Exemplary arrangements provide frame components that are included in vehicle structures such as for example, vehicle side frames, vehicle floor members and vehicle frame longitudinal members. Exemplary arrangements provide the capability of producing frame components and vehicle structures that have increased strength and lower overall weight.

Exemplary arrangements include a frame component that includes a first wall comprised of at least one metal sheet and a second wall comprised of at least one metal sheet. The walls are disposed away from one another to provide an interior gap between the walls. The interior gap extends between the inside surfaces of the first wall and the second wall. The sheets are operatively joined together such that the gap between the sheets is hermetically sealed.

A fluid connector is in operative connection with at least one of the first wall and the second wall. The fluid connector is configured to deliver pressurized fluid through the connector and a respective wall into the interior gap between the walls. The introduction of the pressurized fluid into the interior gap is operative to increase the strength of the frame component beyond that that would be achieved by the structure absent the delivered fluid. As used herein increased strength refers to a higher resistance force to deformation such as a compression, bending and/or torsion.

In some exemplary arrangements the fluid pressure is operative to permanently deform at least one of the first wall or the second wall. Such deformation caused by the delivery of the fluid into the interior gap further operates to provide wall profiles that have desirable properties. This may include for example increased strength as well as providing areas that are intended to be deformed to absorb energy in the event of a collision to protect the vehicle occupants. In some exemplary arrangements the controlled deformation of the walls of the frame component is carried out by the delivery of the fluid into the interior gap while one or more walls of the frame component is held by adjacent pressure plates or other structures that provide for controlled deformation of the wall surfaces and desired final internal or external contours. Such external contours may include flattened surface areas on the wall surfaces or desired contoured areas of the wall surfaces as may be usable to achieve desired properties of the vehicle structure in the areas of the frame component.

In other exemplary arrangements the frame component may include a pocket in the sealed interior area between the first wall and the second wall. In such exemplary arrangements the pocket includes an interior area that is bounded by a pocket wall. The fluid connector is configured to deliver the pressurized fluid into the pocket interior area. Further in some exemplary arrangements the delivery of pressurized fluid is operative to cause the pocket wall to permanently deform. The delivery of the pressurized fluid into the pocket, and in some arrangements the deformation of the pocket within the gap between the first and second walls is operative to increase strength of the frame component.

In some exemplary arrangements the first wall and the second wall have a variable transverse thickness in different regions across the frame component. The difference in transverse wall thickness in the various regions may be achieved in exemplary arrangements through forming or machining processes that are associated with forming the wall surfaces. Such processes in some arrangements may enable a single continuous sheet to have a transverse thickness that varies with unbroken smooth continuity from region to region. Alternatively or in addition, variable transverse thickness of the sheets may be achieved by providing multiple sheets joined in overlapping fixed relation to produce a wall of the frame component. In some arrangements the multiple sheets may be of the same material or may be comprised of different materials.

In exemplary arrangements the utilization of different transverse wall thickness in different regions, which are also referred to as areas, of the frame component enables selectively controlling the permanent deformation that is imparted to the walls as a result of the introduction of the fluid into the interior gap. Further varying the transverse thickness and properties of the walls in different regions enables selectively controlling the strength of the particular region as well as the magnitude and direction of forces that will cause deformation of the frame component during a collision to absorb energy.

In exemplary arrangements the pressurized fluid that is introduced into the sealed interior gap between the walls may be varied with the materials being used as well as the desired strength and other properties to be achieved by the frame component. Fluids that may be used in certain arrangements include air, nitrogen containing gases, inert gases, water-based liquids, petroleum-based liquids, non-Newtonian fluids, foams, fluid cement, fluid concrete, flowable natural materials (such as natural rubber) and fluid plastic polymers. In some exemplary arrangements the fluids may be configured to remain within and cure and harden after introduction to the gap, while in other arrangements the fluids introduced may remain in a gaseous or liquid state or may be removed. Different approaches may be taken to achieve the desired frame component properties. Further in exemplary arrangements the fluid connector which is utilized to introduce the fluid into the sealed interior area of the frame component may be in operative connection with a check valve, which prevents the fluid from flowing out of the gap. In other exemplary arrangements the connector may be associated with a relief valve arrangement that is configured to enable the fluid to escape in the event that the fluid pressure exceeds a set level. Of course numerous different approaches may be used.

In exemplary arrangements one or more of the frame components may be configured to be integrated into a vehicle structure that provides the desired strength and rigidity of the vehicle structure. In exemplary arrangements the frame component is integrated into vehicle structures that are part of a motor vehicle such as an internal combustion engine powered, electric or hybrid powered vehicle. In some exemplary arrangements the frame component is integrated into a vehicle side frame, which is configured to provide strength to a respective side surface of the vehicle. Such a vehicle side frame may include the structures that operatively bound an access opening to an interior area of the vehicle. In such exemplary arrangements commonly a pair of vehicle side frames are utilized, and multiple portions of the vehicle structure may include respective frame components integrated therein.

In other exemplary arrangements the exemplary frame component may be integrated into a vehicle structure such as a floor member. In exemplary arrangements the floor member may comprise a plurality of structures such as annular structures that provide a lower platform or other support of the vehicle structure. For example in some arrangements such floor members may provide the support and/or housing structures for items such as batteries, fuel tanks, motors, engines or other similar vehicle components. Such floor members may also provide the structures that operatively bound the vehicle passenger compartment. Such floor members may include multiple different portions depending on the nature of the vehicle. In exemplary arrangements each of the different structures of the floor member may include frame components which provide enhanced strength and/or desired controlled deformation or other properties.

In other exemplary arrangements exemplary frame components may be integrated into other structures such as vehicle frame longitudinal members. Such vehicle frame longitudinal members may include central portions that are configured to be positioned in a central area of the vehicle. Such frame longitudinal members may further include a front portion that is configured to be directed from the central portion and toward the front of the vehicle. Other exemplary arrangements may include rear portions configured to be directed from the central portion and toward the rear of the vehicle. Other exemplary arrangements may include transition portions and/or annular portions which provide certain properties and/or facilitate controlled deformation. Such transition portions may be positioned intermediate of the central portion and the front portion and/or the rear portion. In exemplary arrangements one or more frame components of exemplary arrangements may be integrated into the vehicle structures associated with the vehicle frame longitudinal member.

Of course it should be understood that these are only some examples of vehicle structures in which frame components of exemplary arrangements may be integrated. Exemplary frame components may be integrated into other vehicle structures as well depending on the particular vehicle construction. For example exemplary frame components may be integrated into door structures, roof structures, roll bars, cargo beds, compartment bounding structures, body panels and other vehicle structures. Further it should be understood that in some exemplary arrangements vehicles may comprise one or more of the exemplary vehicle side frame, vehicle floor member and vehicle frame longitudinal member structures that are discussed herein. In exemplary arrangements one or more of such structures that are included as parts of a single vehicle may each include one or more of the vehicle frame component structures as described herein.

In exemplary arrangements the exemplary frame component structures may be produced utilizing methods which result in frame components and vehicle structures which have the desired features and properties for the particular vehicle structure. In exemplary arrangements the methods may include producing a preform structure. For purposes hereof a preform structure shall be considered to be a structure having the preliminary shape, transverse thickness and materials of the desired frame component. In an exemplary arrangement the method is carried out by joining in engaged relation a first wall comprising at least one metal sheet and a second wall comprising at least one further metal sheet, such that the first wall and the second wall bound a hermetically sealed interior gap between the walls. The exemplary method further includes delivering via a fluid connector, pressurized fluid into the interior gap and through the first wall or the second wall. The delivered fluid is operative to increase the strength of the frame component.

In further exemplary methods the delivered fluid may be operative to permanently deform one or both of the first wall and the second wall to provide desired surface contours. In some exemplary methods pressure plates or other bounding structures may be utilized during deformation to achieve desired surface contours. Likewise different regions of the walls may have different transverse thicknesses and/or different material properties to achieve desired deformation and frame component configurations.

Further in some exemplary arrangements a hermetically sealed pocket may extend between the walls in the interior gap. Fluid may be delivered into the pocket in various methods so as to provide added strength. Alternatively or in addition in some further methods the fluid introduced into the pocket may cause permanent deformation of the pocket wall that bounds the pocket within the interior gap. Numerous additional or different method steps may be utilized for purposes of producing the desired frame components and vehicle structures.

Additional features and relationships of exemplary arrangements are described in further detail in the appended drawings and the following Detailed Description.

### BRIEF DESCRIPTION OF DRAWINGS

FIG. 1 is a front top right perspective view of a vehicle unibody frame structure which includes a pair of vehicle side frame structures each of which incorporate at least one frame component of an exemplary arrangement.

FIG. 2 is a side view of an exemplary vehicle side frame of an exemplary arrangement with different wall thickness in different regions.

FIG. 3 is a side view of an exemplary vehicle side frame of an alternative exemplary arrangement.

FIG. 4 is a transverse cross-sectional view of a vehicle side frame preform during one of the steps in a method of manufacturing the vehicle side frame.

FIG. 5 is a transverse cross-sectional view of an exemplary frame component during a step of manufacturing the vehicle side frame.

FIG. 6 is a transverse cross-sectional view of an exemplary frame component.

FIG. 7 is a further transverse cross-sectional view of an exemplary frame component.

FIG. 8 is a side view of a further vehicle side frame that includes an exemplary frame component without an outer wall to show the interior structures.

FIG. 9 is a transverse cross-sectional view along line 9-9 in FIG. 8 showing a portion of the vehicle side frame of FIG. 8.

FIG. 10 is a side view of a further vehicle side frame of an exemplary arrangement without an outer wall to better show the interior structures.

FIG. 11 is a transverse cross-sectional view along line 10-10 in FIG. 10 showing the vehicle side frame according to FIG. 10.

FIG. 12 is a side view of a further exemplary vehicle side frame shown without an outer wall to better show the interior structures.

FIG. 13 is a cross-sectional side view along line 13-13 in FIG. 12 showing a portion of the side frame.

FIG. 14A is a side view of an exemplary vehicle side frame manufactured with prior art technology with indicated evaluation conditions for the strength parameter in the form of compression along the vertical axis Z.

FIG. 14B is a side view of the exemplary vehicle frame of FIG. 14A with indicated evaluation conditions for the strength parameter in the form of compression along the horizontal axis X.

FIG. 15A is a side view of an exemplary vehicle side frame including at least one frame component of an exemplary arrangement with indicated evaluation conditions for the strength parameter in the form of compression along the vertical axis Z.

FIG. 15B is a side view of the exemplary vehicle side frame of claim 15A with indicated evaluation conditions for the strength parameter in the form of compression along the horizontal axis X.

FIG. 16A is a side view of the further alternative vehicle side frame known in the prior art with indicated evaluation conditions for the strength parameter in the form of compression along the vertical axis Z.

FIG. 16B is a side view of the vehicle side frame according to FIG. 16A with indicated evaluation conditions for the strength parameter in the form of compression along the horizontal axis X.

FIG. 17 is a top front right perspective view of a vehicle unibody frame which includes a floor member with at least one frame component of an exemplary arrangement.

FIG. 18 is a top front right perspective view of an exemplary floor member including at least one frame component of an exemplary arrangement.

FIGS. 19-28 are top plan views of exemplary vehicle floor members that each include at least one frame component of exemplary arrangements.

FIGS. 29-31 are top front right perspective views of exemplary vehicle floor systems that include a pair of disposed floor members each of which include a frame component of exemplary arrangements.

FIG. 32A is a cross-sectional view of an exemplary vehicle floor member that includes at least one frame component of an exemplary arrangement.

FIG. 32B is a cross-sectional view of an alternative exemplary vehicle floor member that includes at least one frame component of an exemplary arrangement.

FIG. 33 is a further cross-sectional view of a further exemplary vehicle floor member that includes at least one frame component of an exemplary arrangement.

FIG. 34 is a transverse cross-sectional view of the exemplary vehicle floor member of FIG. 27 along line 34-34.

FIG. 35 is a transverse cross-sectional view of the exemplary vehicle floor member of FIG. 26.

FIG. 36 is a displacement map for an exemplary vehicle floor member that includes at least one frame component of an exemplary arrangement.

FIG. 37 is a further displacement map for exemplary vehicle floor member that includes at least one frame component of an exemplary arrangement.

FIG. 38 is in exemplary displacement map for a vehicle floor member manufactured using prior art techniques.

FIG. 39 is a further displacement map for a vehicle floor member manufactured using prior art techniques.

FIG. 40 is a top front right perspective view of a vehicle unibody that includes a pair of vehicle frame longitudinal members, each of which members include at least one frame component of an exemplary arrangement.

FIG. 41 is a side view of an exemplary vehicle frame longitudinal member of the type shown in FIG. 40.

FIG. 42 is a side view of a vehicle frame longitudinal member of the type shown in FIG. 41.

FIG. 43 is a top front right perspective view showing a pair of vehicle frame longitudinal members of the type shown in FIG. 41 integrated in a vehicle structure.

FIG. 44 is a transverse cross-sectional view along line 44-44 of an exemplary vehicle frame component integrated in a vehicle frame longitudinal member.

FIG. 45 is a side view of an alternative vehicle frame longitudinal member.

FIG. 46 is a side view of an exemplary vehicle frame structure including the vehicle frame longitudinal member of FIG. 45.

FIG. 47 is a perspective view of the vehicle structure of FIG. 46 showing a pair of vehicle frame longitudinal members of FIG. 45 integrated in a vehicle structure.

FIG. 48 is a transverse cross-sectional view of a frame component of the exemplary vehicle frame longitudinal member along line 48-48 of FIG. 46.

FIG. 49 is a side view of an alternative vehicle frame longitudinal member that includes at least one frame component of an exemplary arrangement.

FIG. 50 is a side view showing the vehicle frame longitudinal member of FIG. 49 integrated in a vehicle structure.

FIG. 51 is a perspective view of a pair of vehicle frame longitudinal members according to FIG. 49 integrated in a vehicle structure.

FIG. 52 is a transverse cross-sectional view showing a frame component included in the exemplary vehicle frame longitudinal member along line 52-52 of FIG. 50.

FIG. 53 is a side view of the further alternative vehicle frame longitudinal member that includes at least one frame component of an exemplary arrangement.

FIG. 54 is a side view of the exemplary vehicle frame longitudinal member of FIG. 53.

FIG. 55 is a side view of the vehicle frame longitudinal member of FIG. 53 integrated in a vehicle structure.

FIG. 56 shows a pair of vehicle frame longitudinal members of FIG. 53 integrated in a vehicle structure.

FIG. 57 is a transverse cross-sectional view of a frame component included in the vehicle frame longitudinal member along line 57-57 of FIG. 55.

FIG. 58 is a perspective view of an exemplary arrangement of a vehicle frame including a prior art vehicle frame longitudinal member.

FIG. 59 is a perspective view of an exemplary vehicle frame longitudinal member that includes a frame component of an exemplary arrangement.

FIG. 60 is a perspective view demonstrating numerical simulation results of the stress distribution map for the exemplary structure of FIG. 59 in torsion testing.

FIG. 61 is a perspective view of an exemplary vehicle body frame that includes frame components of exemplary arrangements in multiple vehicle structures.

### DETAILED DESCRIPTION

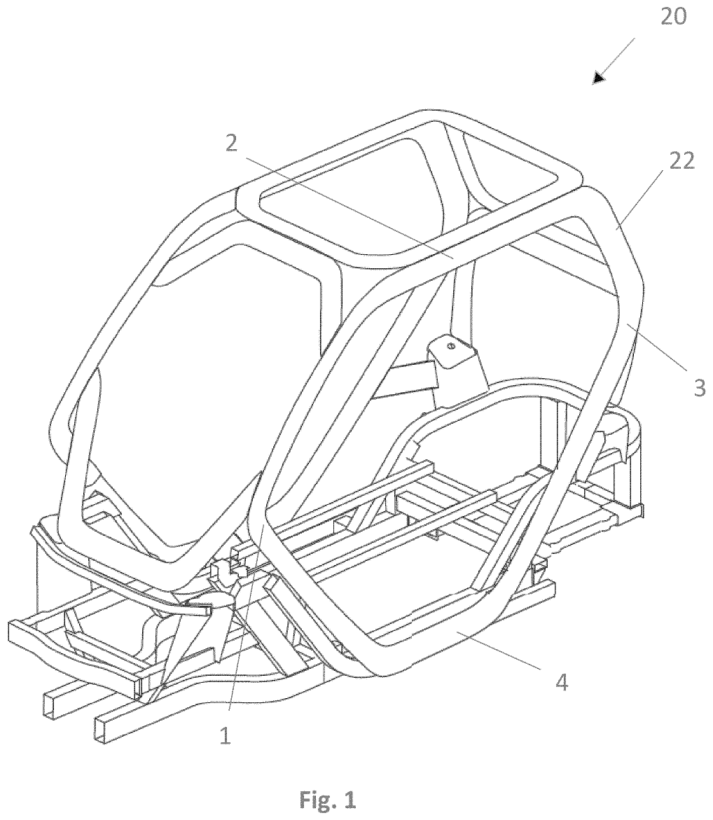

Referring now to the drawings and particularly to FIG. 1 there is shown therein an exemplary vehicle unibody frame structure 20. The exemplary frame structure 20 includes a pair of vehicle side frames 22. The exemplary side frames each include at least one exemplary frame component as described later herein. Each vehicle side frame 22 is produced via a method that begins with assembly of a preform member which is subject to process steps later described to achieve the desired vehicle side frame configuration and properties.

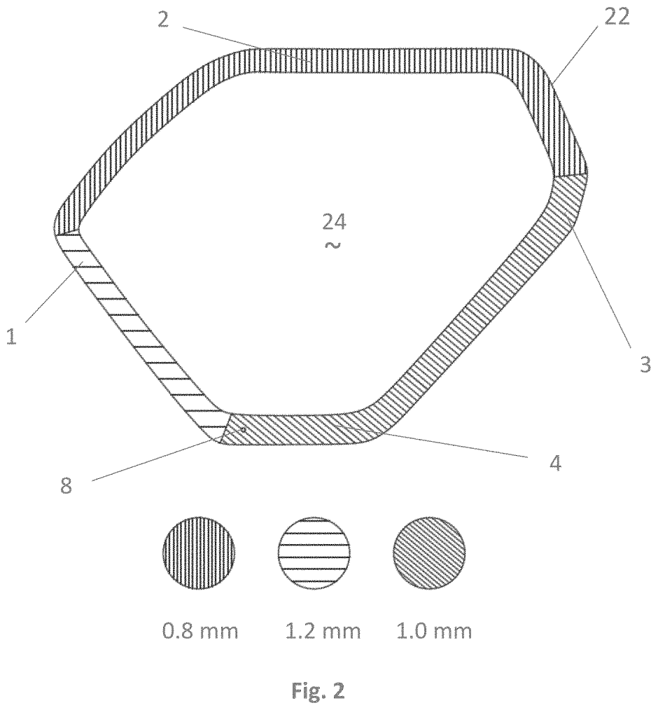

In the exemplary arrangement the side frame 22 has an annular structure as shown in FIG. 2. The exemplary side frame and the portions thereof are configured to operatively bound a vehicle access opening 24. In exemplary arrangements the vehicle access opening 24 may be an opening configured to receive the door or other movable closure member used to control access to a compartment such as a vehicle passenger compartment.

The exemplary vehicle side frame 22 includes a front pillar portion 1. The front pillar portion is connected to a roof frame portion 2. The roof frame portion 2 extends to a rear pillar portion 3. The rear pillar portion extends to a sill portion 4, which is connected to the front pillar portion. In an exemplary arrangement these portions are connected to one another and form an annular frame structure. Of course it should be understood that this particular vehicle side frame structure is exemplary and in other arrangements other configurations may be used.

In exemplary arrangements a frame component of a vehicle side frame is comprised of an inner wall 6 and outer wall 7. Each of the inner wall and the outer wall are comprised of at least one metal sheet. In some exemplary arrangements the at least one metal sheet of each of the walls does not have a uniform cross-sectional thickness across the entire structure. Rather in some exemplary arrangements each of the areas (which are also referred to herein as regions) shown with different hashing, have a transverse cross-sectional wall thickness that is different from other regions of the particular wall. This exemplary approach of having different transverse cross-sectional wall thicknesses in different regions of each of the walls may be referred to herein as a patchwork arrangement. This approach of regions of variable transverse wall thickness are used in exemplary arrangements to provide desired strength properties and areas for controlled deformation and energy absorption of the exemplary vehicle side frame members.

As represented in FIG. 2 the exemplary vehicle side frame has three different regions. Each of these regions has walls with a different transverse cross-sectional wall thickness. In this exemplary arrangement each of the walls is comprised of a stainless steel sheet. Of course it should be understood that in other arrangements other materials or combinations of materials may be used. As shown in FIG. 2 in the exemplary arrangement the walls in a region that includes the lower portion of the front pillar portion of the frame has a wall thickness of 1.2 mm. In this exemplary arrangement a region that includes an upper portion of the front pillar 1, the roof portion 2 and an upper portion of the rear pillar 3 comprises a second region with a transverse wall thickness of 0.8 mm. Further in this exemplary vehicle side frame a further region that includes the lower portion of the back pillar 3 and the sill 4 have walls with a thickness of 1.0 mm. Of course it should be understood that this particular configuration and wall thickness arrangement is exemplary and in other arrangements other configurations, thicknesses and materials may be used.

In this exemplary arrangement of the vehicle side frame 22 each of the metal sheets 6, 7 that comprise the walls have varying thicknesses in the different regions of the vehicle side frames to achieve desired functional characteristics. As a result the vehicle side frame has different properties of strength and rigidity in the regions having the higher transverse sheet thicknesses. In the exemplary arrangement the variations in thickness of the at least one metal sheet that comprises the respective walls 6, 7 may be achieved in different ways. This may include for example using approaches such as press forming, rolling and joining multiple sheets having different thicknesses. Such joining may be accomplished through numerous different methods such as by welding, gluing, melting or other different attachment and joining approaches.

In other exemplary arrangements varying sheet thicknesses for the walls that bound the frame component of vehicle side frame structure may not be utilized. For example in some arrangements the wall thicknesses of each of the walls may be uniformly the same, or may begin as a preform structure in which the wall thicknesses on each side thereof are uniformly the same. However it should be understood that in alternative arrangements the walls may be made of different materials and may have different transverse thicknesses to achieve the desired properties of the vehicle structure. Further in other exemplary arrangements multiple overlying metal sheets may be utilized to form respective walls of the exemplary frame component structure. Such sheets may be of different thicknesses and materials depending on the properties that are desired for the particular vehicle frame structure.

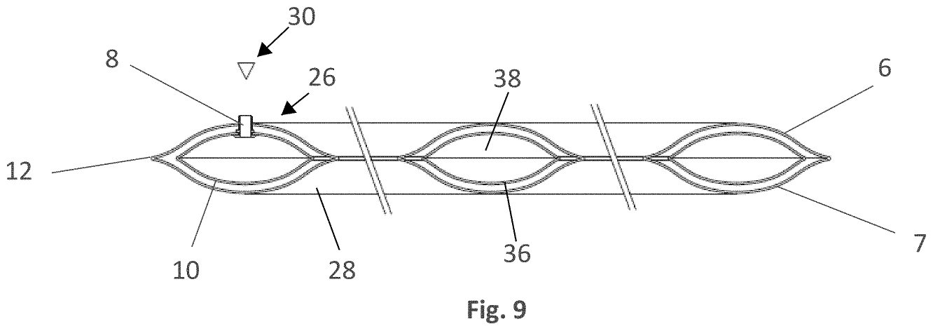

In exemplary arrangements vehicle frame structures include at least one frame component that is configured to be integrated in a vehicle structure to provide added strength. Such an exemplary frame component 26 is shown for example in FIG. 9. In an exemplary arrangement the frame component 26 includes a first wall 6 which is alternatively referred to herein as an inner wall, and a second wall 7 which is alternatively referred to herein as an outer wall. In some exemplary arrangements the first wall may be positioned in the assembled vehicle structure such that it is in facing relation with the inner side of a vehicle structure in which the frame component structure is integrated. Likewise the second wall is in facing relation toward the outside of the vehicle structure. Of course this arrangement is exemplary. In an exemplary arrangement the first wall 6 and the second wall 7 of the frame component are arranged in generally parallel alignment. As used herein generally parallel alignment refers to the walls being parallel with an angle of each wall relative to the other of plus or minus 30°.

In the exemplary arrangements the frame component that is integrated into the side frames or other structures includes a sealed interior gap 28. The exemplary sealed interior gap extends intermediate of the inside faces of the first wall 6 and the second wall 7. In exemplary arrangements the hermetically sealed interior gap is formed by the walls being hermetically sealed in operatively joined connection. In exemplary arrangements the walls may be joined in hermetically sealed connection by welding or other sealing or joining methods.

The exemplary frame component 26 further includes a fluid connector 8. The exemplary fluid connector which may be alternatively referred to herein as a valve element, provides a connector that enables a fluid such as a gas or liquid to pass therethrough and through one of the walls and into the interior gap 28. As shown in the exemplary arrangement in FIG. 9, the fluid connector extends on the first wall 6 and provides a fluid passage into the interior gap 28. In an exemplary arrangement the fluid connector 8 is configured for connection in a leakproof manner to an external source of pressurized fluid. In exemplary arrangements the fluid connector enables the delivery of the pressurized fluid through the connector and through the wall 6 and into the interior gap 28. Of course it should be understood that in other arrangements the fluid connector may be in operative connection with and deliver the pressurized fluid through the outer wall 7. Further in other exemplary arrangements multiple fluid connections may be utilized for purposes of delivering pressurized fluid (and evacuating air which may impede fluid delivery) through each of the walls that bound the respective sealed interior gap 28 of the respective frame component 28.

Further in some exemplary arrangements the fluid connector 8 may be in operative connection with a valve element schematically indicated 30. In some exemplary arrangements the valve element 30 may provide the function of a check valve. The exemplary check valve may enable the pressurized fluid to be delivered into the sealed interior gap 28 while preventing the escape of fluid therefrom. In such arrangements the check valve may help to assure that the fluid that is delivered into the hermetically sealed interior gap is retained therein for purposes of increasing the strength of the frame component and the associated vehicle structure in which the frame component is integrated.

In other exemplary arrangements the valve element 30 may comprise a pressure relief valve. In such exemplary arrangements the pressure relief valve may be operative to release the fluid from the gap in the event that the pressure thereof exceeds a set relief pressure. Such a valve element in exemplary arrangements may provide for controlled release of the pressure as a result of deformation of the frame component in a collision or in other circumstances where it may be desirable to release the fluid provide controlled deformation of the frame component structure. Of course it should be understood that this arrangement is exemplary and other arrangements other approaches may be used.

In some exemplary arrangements of the frame component 26 the walls are joined in operatively hermetically sealed engagement via a seal generally indicated 12. In the exemplary arrangement shown the outer and inner edges of the walls are joined through suitable welding and/or other sealing methods as necessary to achieve a fluid tight, hermetically sealed interior area. This may be done for example in the fabrication of a suitable preform structure of the vehicle side frame or other vehicle structure that includes the frame component. However in other arrangements other structures may be utilized in intermediate relation of the walls to provide a suitable sealed enclosure for the interior gap.

In some exemplary arrangements a sealing process step is performed by joining the edges of the walls 6, 7, each of which comprise at least one metal sheet. The sealing process is carried out after the walls have been matched in aligned and overlying relation with one another. In exemplary arrangements the sealing step is performed on the circumferential edges of the matched walls 6, 7 of the vehicle side preform which include the frame component structure. In some exemplary arrangements sealing may be performed by welding the corresponding edges together resulting in the formation of the circumferential welds. In exemplary arrangements by sealing the circumferential edges a leakproof hermetic sealed interior gap 28 is formed between the inner surfaces of the walls of the frame component of the vehicle side preform. Of course it should be understood that this approach to joining the walls in hermetically sealed relation is exemplary and in other arrangements other process steps, structures and materials may be used. For example the at least one sheet which comprises each respective wall, or in some cases intermediate structures which bound the sealed interior gap, may be joined by approaches that include welding, soldering, gluing, bending, pressing, molding, caulking or other suitable approaches for achieving hermetically sealed operative connection of the first wall and the second wall.

In exemplary arrangements in producing an exemplary vehicle side frame that includes one or more of the exemplary frame component structures that provide increased strength and other suitable properties, the walls 6, 7 may be joined in operative connection at the circumferential edges. Further additional sealing steps or structures may be added or applied to achieve a sealed interior gap 20 between the walls that is in hermetically sealed connection. Such sealing may include the application of suitable seal materials or the use of other sealing steps to assure that the interior gap of the frame component comprises a hermetic inner empty space that is leakproof with respect to the fluid that is to be introduced into the sealed interior area. Various approaches may be taken in exemplary arrangements to achieve these properties, and the approaches utilized may vary with the particular type of pressurized fluid that is to be delivered into the sealed interior gap.

In exemplary arrangements in the method of producing the frame component which provides additional strength and/or other properties to the vehicle structure in which it is integrated, an external source of pressurized fluid is connected to the fluid connector 8 through a suitable supply conduit. In some exemplary arrangements the fluid may comprise compressed air at an elevated pressure. However in other exemplary arrangements the fluid may include other types of gases such as an inert gas or nitrogen containing gas. In other exemplary arrangements the fluid may include a water-based liquid, a petroleum-based liquid, a non-Newtonian fluid, a fluid cement, fluid concrete, a flowable natural material such as liquid rubber, a fluid plastic such as a fluid plastic polymer, or a foam material. For example in some exemplary arrangements the fluid plastic that is delivered through the connector 8 may comprise a one, two or three component foam (such as a flex 140 type). In various exemplary arrangements the fluid may be of a type that remains in its initial gaseous or liquid state after being introduced into the sealed interior gap. In other exemplary arrangements the introduced liquid may cure which results in the fluid having other properties. For example in some exemplary arrangements the fluid may harden as it cures into a suitable solid or semi solid material which is housed within the sealed interior gap to provide the desired properties. In other arrangements the fluid may deform or coat the surfaces bounding the interior gap and then be removed.

In exemplary arrangements the fluid that is delivered into the sealed interior gap may be delivered in various ways to assure that a defined pressure and/or a defined quantity of the material is delivered into the interior gap. Various approaches for introducing the fluid material may be utilized to assure that the interior gap achieves the desired internal pressures as may be desired to achieve the additional strength of the frame component in its location within the particular vehicle structure.

In some exemplary arrangements such as for example the arrangement shown schematically in FIG. 7, the fluid pressure that is delivered into the sealed interior gap 28 between the walls 6, 7 is operative to cause permanent deformation of the at least one metal sheet that comprises one of the walls. Further in other exemplary arrangements the at least one metal sheet of each of the walls 6, 7 is caused to undergo permanent deformation as a result of the introduced pressurized fluid. As represented in FIG. 7 each of the walls 6, 7 are permanently deformed (as shown in the right side of the Figure) compared to the initial configuration of the preform structure used to produce the frame component (which is shown on the left in the Figure). As can be appreciated the controlled permanent deformation of the walls that is produced as a result of the delivery of fluid pressure, provides a frame component 26 that has increased strength as a result of the deformation of the walls to a desired configuration and also as a result of the fluid that is delivered into the sealed interior gap 28.

In exemplary arrangements of the vehicle side frame structure 22, frame components which are deformed and strengthened through the introduction of pressurized fluid are included in the front pillar portion 1, the roof frame portion 2, the rear pillar portion 3 and the sill portion 4. Of course it should be understood that the selection of the particular wall thicknesses, extent of deformation, dimensions and configurations of the frame components integrated in the vehicle side frame structure are selected to achieve the desired operational and safety parameters. These include the rigidity and strength of the structure as well as the inclusion of controlled deformation zones within the vehicle side frame structure and other structures to which the vehicle side frame is operatively connected. Various approaches may be taken to achieve the desired capabilities of the particular vehicle structure.

In exemplary arrangements the introduction of the fluid to the hermetically sealed interior gap area of the frame component may be done at room temperatures, or in other environments or conditions. Different environmental conditions for the process of producing the particular frame components and vehicle structures may depend on the particular materials and fluids that are utilized. For example in the making of a vehicle side frame such as is shown in FIG. 1, in some exemplary arrangements the exemplary process may be carried out utilizing air as the fluid. The introduction of the fluid may be carried out in an environment with an ambient temperature of about 20° C. In some exemplary arrangements the working pressure may be in the range of about 5 bar. The time during which the walls which bound the sealed interior gap undergo deformation is approximately one minute which is the time required for pressure of the fluid that is introduced through one of the walls to be equalized in the sealed interior gap. The maximum pressure delivery and hold time may be in the range of approximately 30 seconds which results in the walls being subject to permanent deformation over time period of approximately 1.5 minutes. Of course it should be understood that this process and the parameters thereof are exemplary and in other arrangements other approaches may be used.

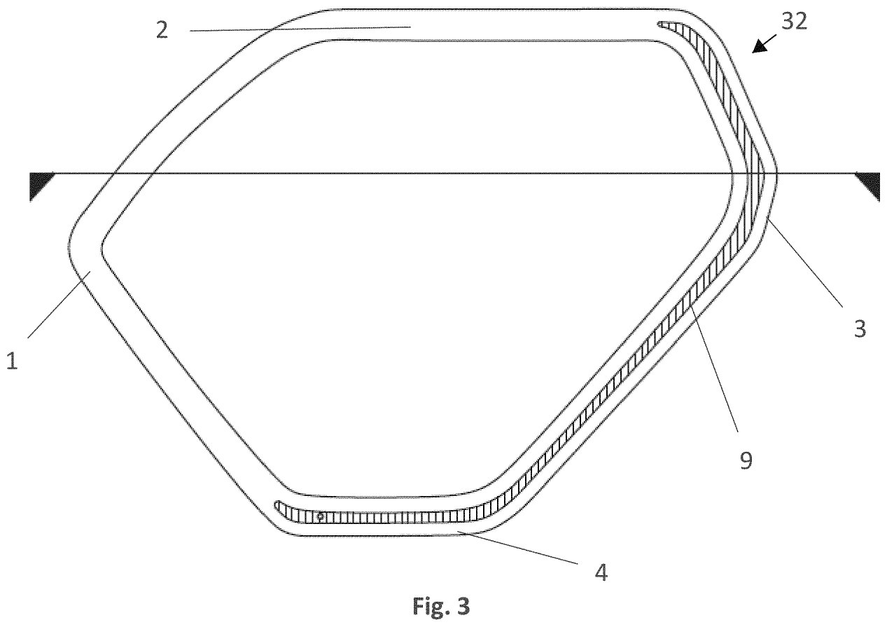

Another exemplary arrangement of a vehicle structure comprising a vehicle side frame 32 is shown in FIG. 3. In this exemplary arrangement the vehicle side frame may have a structure that includes at least one frame component of the type previously discussed. The exemplary vehicle side frame is produced from a preform structure that includes at least one frame component generally of the types discussed in connection with FIG. 1.

In the exemplary arrangement vehicle side frame 32 includes flattened regions 9 that extend on the inner wall 6 and on the outer wall 7 of the frame component structure. In this exemplary arrangement the flattened regions have a substantially flat external surface. The exemplary flattened regions 9 enable the attainment of desired properties of the vehicle side frame. Such flattened regions may also provide suitable mounting areas for structures included in the particular vehicle.

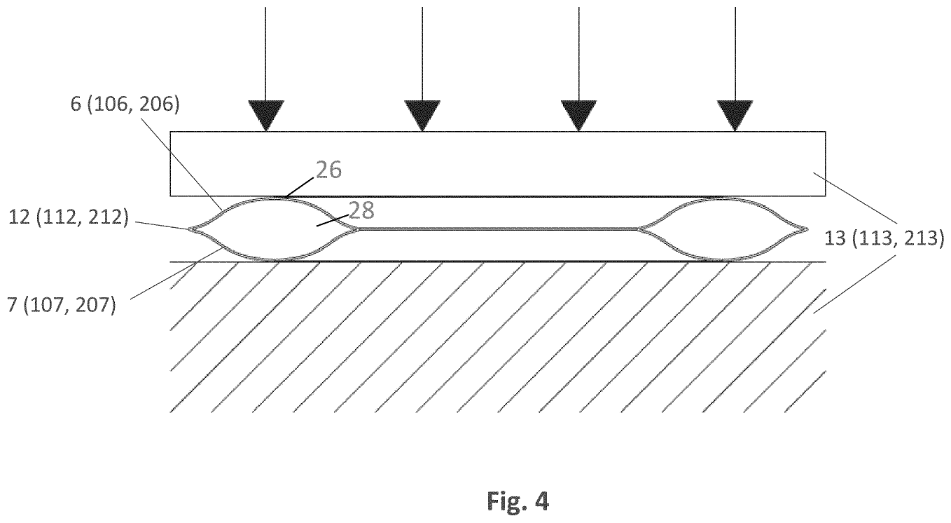

In the exemplary arrangements the flattened regions of the walls is achieved through permanent deformation of the walls while such walls are positioned intermediate of pressure plates 13 or other similar structures that restrict the amount of deformation and which determine the final configuration of the walls of the frame component structure. In exemplary arrangements during the introduction of the pressurized fluid into the sealed interior gap 28, the force of the pressure plates acting against the deforming walls 6, 7 cause the walls to deform in a manner that corresponds to an abutting portion of the pressure plates. This is represented for example in FIG. 4. Further in some exemplary arrangements the pressure plates may comprise movable elements that provide opposing forces against portions of the walls, rather than just comprising stationary elements that oppose the force applied by the adjacent deformable wall. For example in some arrangements the pressure plates 13 may comprise the working elements of a mechanical press or similar structure.

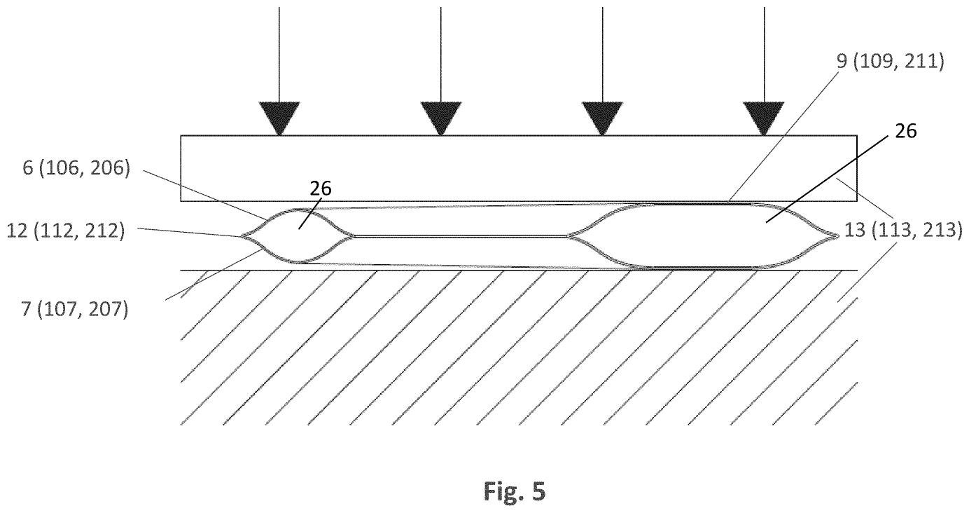

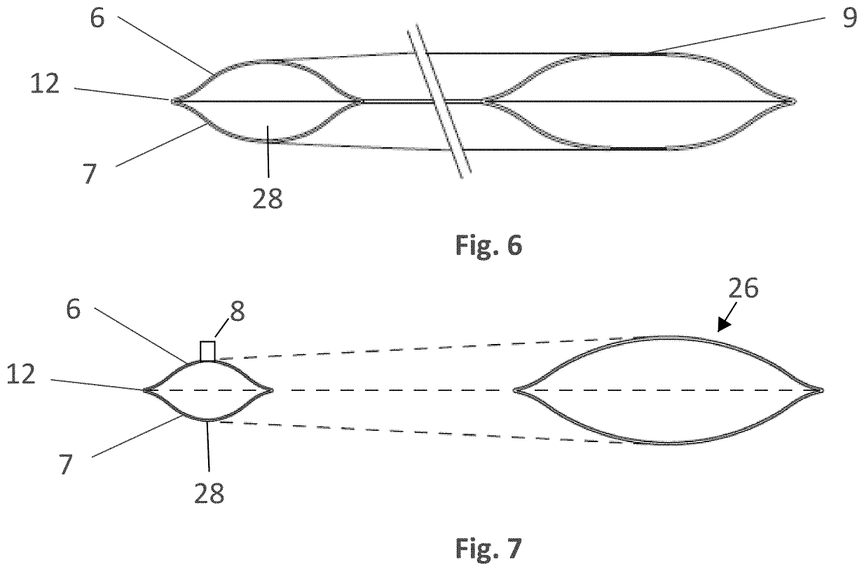

In some exemplary arrangements the pressure plates may be operated to provide a controlled force in a direction towards the immediately adjacent wall of the frame component of the vehicle side frame preform. During the step of delivering the pressurized fluid into the sealed interior gap 28, the frame component 26 is held in intermediate relation of the pressure plate 13 and a fixed plate structure or alternatively a pair of opposed movable pressure plates. In accordance with exemplary arrangements the walls of the exemplary frame components are deformed to have flattened regions 9 of the desired configurations in the regions where the surfaces of the pressure plates 13 are engaged with the respective outer surfaces of the walls 6, 7. This is represented for example by the flattened regions 9 shown on the frame component 26 shown on the right side of FIGS. 5 and 6. Of course it should be understood that in other exemplary arrangements pressure plates may be used which impart other types of desired contours to the walls of the frame component.

In some exemplary arrangements it may be desirable to provide frame components that are deformed in a free manner without flattened regions in certain areas of the vehicle structure such as the vehicle side frame. This may be done to achieve the particular desired properties in the area of the frame component. For example in FIGS. 5 and 6 on the left side, a frame component 26 is shown formed in a free manner without being in contact with the pressure plates. As represented in FIGS. 5 and 6 the frame component shown on the left side does not include the flattened regions 9 on its external wall surfaces.

FIGS. 5 and 6 show for example that in some exemplary arrangements a single vehicle structure may include a plurality of frame components which are integrated therewith to provide frame components with different dimensions and external configurations. Such differing frame components may be useful for achieving desired configurations and properties in different regions of vehicle structures. For example certain surface configurations may be flattened or have otherwise desirable surface configurations to provide locations for mounting areas for vehicle equipment. Alternatively or in addition the characteristics of the frame components may provide different properties such as different degrees of strength and resistance to deformation or may be suitable to provide a frame component which serves as a desired area of deformation in the event of a vehicle collision.

Further it should be understood that in exemplary arrangements different materials as well as differing transverse wall thicknesses may be utilized in different frame components to achieve desired wall configurations and properties of the particular area of the frame component in the vehicle structure. Additionally the nature of the pressurized fluid that is introduced into the sealed interior gap 28, as well as the amount, properties and pressure conditions of the fluid that is retained in the sealed interior gap after the manufacturer of the frame component has been completed may enable tailoring the particular properties of the frame component and the vehicle structure to that desired for the particular vehicle application.

Of course it should be understood that these approaches are exemplary and in other arrangements other approaches may be used.

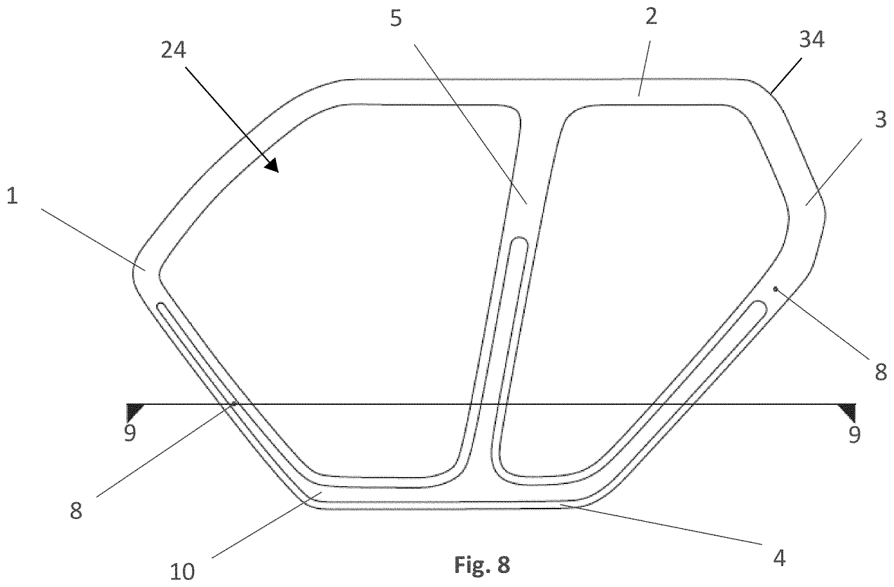

FIG. 8 shows a further alternative exemplary arrangement of a vehicle side frame 34. This exemplary vehicle side frame is shown without the wall 7 to better show the internal structures of this exemplary vehicle side frame.

The exemplary vehicle side frame 34 includes portions similar the vehicle side frames 22 and 32 previously discussed. These include a front pillar portion 1, a roof frame portion 2, a rear pillar portion 3 and a sill portion 4. In addition vehicle side frame 34 further includes a central pillar portion 5. The exemplary central pillar portion 5 extends intermediate of the front pillar portion and the back pillar portion. The central pillar portion 5 further extends in operatively engaged relation with each of the roof portion and the sill portion. In the exemplary arrangement the pillar portion 5 may serve to divide the vehicle access opening 24 which is bounded by the vehicle side frame. This may be done for example to provide a pair of side-by-side openings into areas of a vehicle passenger compartment. Alternatively this arrangement may be suitable for providing an opening into a passenger compartment with a vertical reinforcement that supports the roof portion above a passenger area as well as a storage area. Further it should be understood that while in the exemplary arrangement the pillar portion 5 extends substantially vertically, in other exemplary arrangements the central pillar portion may extend at different angles across the vehicle access opening depending on the desired strength or other characteristics that are desired.

In this exemplary arrangement the frame component 26 extends in each of the front pillar portion 1, the central pillar portion 5, the rear or back pillar portion 3 and the sill portion 4. In the exemplary arrangement the frame component includes the first or inner wall 6 and the second or outer wall 7 as shown in the cross-section taken along line 9-9 in FIG. 8. In this exemplary arrangement as shown in FIG. 9, the sealed interior gap 28 between the walls 6, 7 includes hermetically sealed pockets 10. Each of the pockets 10 are comprised of a pocket wall 36 that bounds a pocket interior area 38 of the respective pocket. In this exemplary arrangement the fluid connector 8 is configured to deliver the pressurized fluid through the wall 6 and the pocket wall 36 and into the pocket interior area 38. In exemplary arrangements the pockets 10 may be formed from metal sheets that are connected with each other and hermetically sealed at the edges. In alternative exemplary arrangements pockets 10 may be comprised of other materials and may have other configurations. In some exemplary arrangements the pocket wall 36 may include materials that do not take on a permanently deformed configuration like metal sheets, but rather may include flexible material such as textiles. Of course it should be understood that these approaches are exemplary and in other arrangements other materials and configurations may be used.

In exemplary arrangements the use of the pocket structures in the sealed interior gap may be utilized to produce different properties of the frame component depending on what is desired. In the exemplary arrangement shown in FIGS. 8 and 9, the exemplary pocket 10 is formed from a sheet of carbon steel, while in the exemplary arrangement the frame component of the vehicle side frame is formed of sheets of stainless steel. This may be done in exemplary arrangements because carbon steel often has a greater hardness and strength then stainless steel. Therefore in some exemplary arrangements the inner pocket 10 is comprised of a material that increases the strength of the frame component 26 and the vehicle structure in which it is integrated, namely the vehicle side frame 34.

Further in exemplary arrangements the pocket may be deformed by the introduction of the pressurized fluid (which in exemplary arrangements may comprise a gas such as air) that is introduced into the pocket interior area 38. In exemplary arrangements the permanent deformation of the pocket wall 36 as well as in some arrangements one or more of the walls 6, 7, may provide for local deformation configurations that provide the desired cross-sectional shape and other properties in the area of the frame component.

Further in other exemplary arrangements in which the pressurized fluid is configured to remain in the pockets 10, may provide other desired properties of the exemplary frame component and the vehicle structure in which the pockets are integrated. Additionally the characteristics of the fluid material which remains within the pockets may help to achieve desired properties and characteristics for the particular areas in which the frame components are integrated. In addition the changes that result from the deformation of the pockets and/or the bounding walls of the sealed interior gap 28 may additionally provide features and strength properties which are desirable for the particular vehicle frame structure. These exemplary approaches enable the vehicle structure to have characteristics and properties that are best suited to the particular design needs while maintaining a suitably light weight.

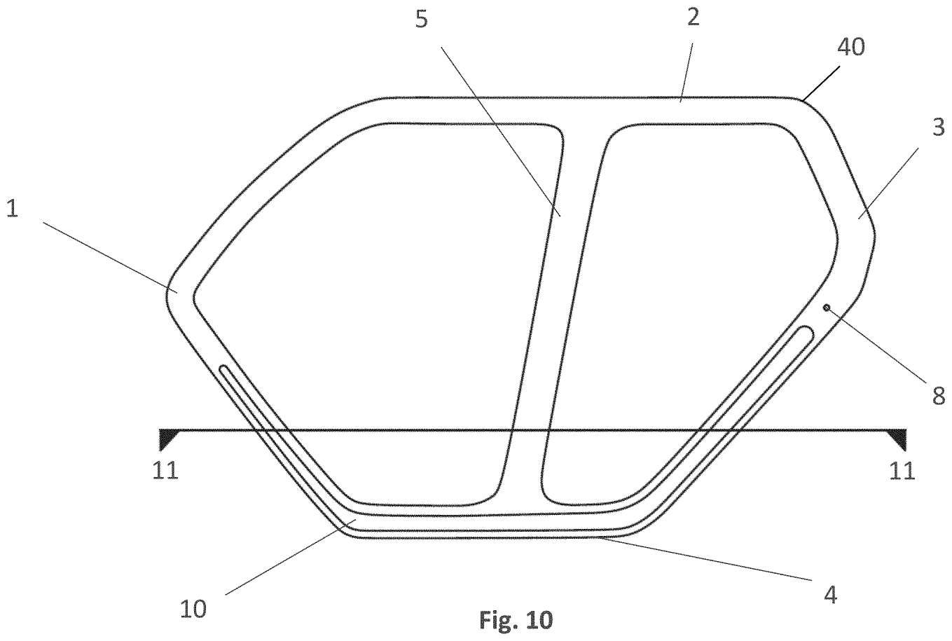

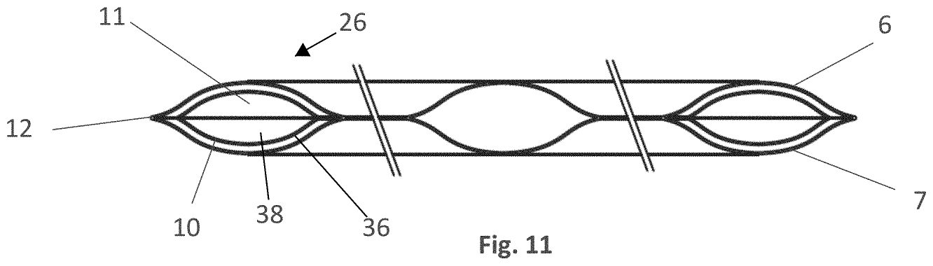

A further exemplary arrangement of a vehicle side frame 40 is shown in FIGS. 10 and 11. This exemplary arrangement is generally similar to the vehicle side frame 34 but does not include a frame component that extends in the central pillar portion 5. In this exemplary arrangement the frame component comprises a sealed interior area with a pocket 10 that has a pocket interior area 38 that is bounded by a pocket wall 36 that is comprised of a flexible textile material such as for example Kevlar®. Further in this exemplary arrangement the pressurized fluid introduced into the pocket interior area 38 comprises a filler 11 which comprises a non-Newtonian fluid. The exemplary filler provides for selectively configured shock absorbing frame components.

In exemplary arrangements the hermetically sealed pockets 10 into which the non-Newtonian fluid is delivered may be assembled as a separate structure that is installed in the vehicle side frame at the time that the preform structure is produced. In other alternative arrangements the configuration of the sealed pockets may be permanently deformed by the introduction of a pressurized fluid initially, which initial fluid is then removed and replaced in the pockets by the non-Newtonian fluid after the final configuration of the metal frame components have been formed. This may be accomplished through the fluid connector 8 and other valve elements like those that have been previously discussed. Thus in such exemplary arrangements the fluid connector 8 serves to introduce pressurized fluid into the pocket interior area 38 through the frame component wall 6 and the pocket wall 36 to provide for wall deformation if desired, thereafter the initial fluid may be removed and the suitable non-Newtonian filler 11 introduced and sealed in place.

Of course it should be understood that in exemplary arrangements the filler 11 that is introduced into the exemplary pockets 10 is not limited to a non-Newtonian fluid. In some exemplary arrangements the filler introduced may provide the desired strength properties, sound deadening properties and/or antivibration properties. For example in some exemplary arrangements the filler material 11 may include a one, two or three component foam or other deformable solid or semi-solid material.

Of course it should be understood that these approaches are exemplary and in other arrangements other approaches may be used.

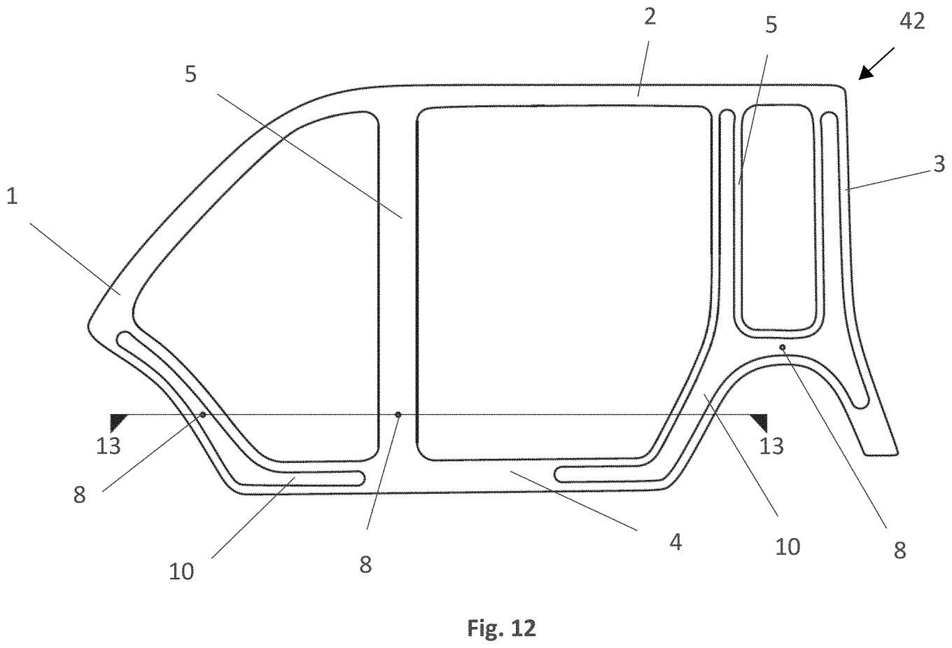

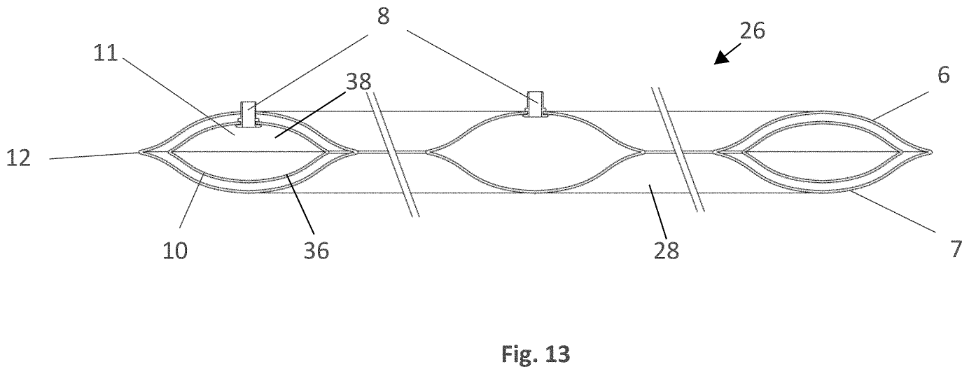

A further alternative exemplary vehicle side frame 42 is shown in FIGS. 12 and 13. The exemplary vehicle side frame 42 includes a plurality of frame components of exemplary arrangements. Vehicle side frame 42 is generally similar to the structure of the previously described vehicle side frames. However vehicle side frame 42 includes two disposed central pillar portions 5. Each of the central pillar portions extend intermediate of the front pillar portion 1 and the rear or back pillar portion 3. Each of the pillar portions extend in operative engaged relation between the roof portion 2 and the sill portion 4. Of course it should be understood that this particular configuration is exemplary.

In this exemplary arrangement the vehicle side frame 42 includes a plurality of frame components 26. Each of the frame components include respective walls 6 and 7 which bound a sealed interior gap 28 in the manner like that previously described. Further the frame components include a pocket 10 that extends in the lower portion of the front pillar portion 1 and the sill 4. A further frame component extends in the rear or back portion 3 and the rear most central pillar 5 as well as the rear portion of the sill 4. Similar to the prior described arrangements each pocket includes a pocket wall 36 that bounds a pocket interior area 38. A respective fluid connector 8 is operative to deliver pressurized fluid into each of the respective pockets.

In exemplary arrangements the respective frame components may have pocket walls that comprise metal sheet that is permanently deformable responsive to fluid pressure. Alternatively in other exemplary arrangements the pocket walls may comprise flexible material that is not permanently deformable. In some exemplary arrangements the pocket interior areas 38 may be filled with a filler 11 that provides additional strength to the particular regions of the vehicle structure in which the frame components extend. In other exemplary arrangements the pocket interior areas may house a foam material that provides soundproofing, antivibration and/or additional strength properties. Further it should be understood that in some exemplary arrangements the frame components may house different types of filler materials depending on the desired properties of the particular frame component. As a result a single vehicle structure may include multiple frame components that house different types of filler materials or other fluid materials to achieve the desired strength and other properties.

Of course it should be understood that these approaches are exemplary and in other arrangements other approaches may be used.

Exemplary arrangements of vehicle structures that include frame components of the exemplary arrangements were produced in accordance with the manufacturing methods described herein. The produced vehicle structures were then subject to comparative tests to determine properties of vehicle structures of exemplary arrangements compared to similar vehicle structures produced by prior art existing methods. FIGS. 14A and 14B show a side view of an exemplary vehicle side frame manufactured by prior art methods. FIG. 14A shows evaluation conditions for strength parameter along the vertical axis Z while FIG. 14B shows evaluation conditions along a horizontal axis X.

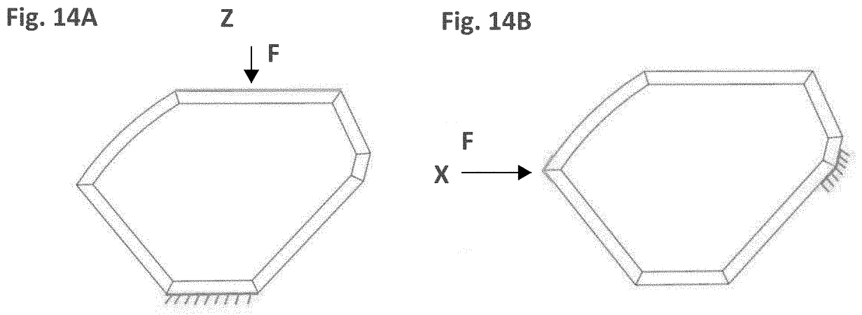

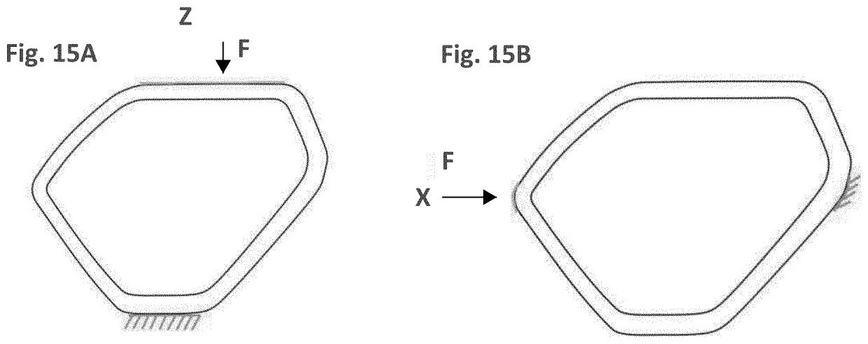

FIGS. 15A and 15B show vehicle side frames generally corresponding dimensionally and geometrically with the side frames shown in FIG. 14. However the vehicle side frames in FIG. 15 were manufactured to include the exemplary frame components of the described exemplary arrangements and were produced by the methods that have been described herein.

Evaluation of the exemplary vehicle side frames shown in FIGS. 14 and 15 was performed for strength parameters in the form of compression along the vertical Z axis and in the form of compression along the horizontal X axis. In exemplary arrangements the force is expressed in newtons per millimeter. In the case of the frames of FIG. 14 the tests were performed for two implementations based on tubular profiles, (which the individual component members of the side frames are made of) with a diameter of 32 mm and with a material thickness of 1.5 mm, and also on a rectangular profile with the dimensions of 45 mm×20 mm and with the material thickness of 1.2 mm. The results of the evaluations were compared against the corresponding strength parameters for the exemplary side frames disclosed herein, manufactured from sheets having a wall thickness of 0.8 mm. The determined strength parameters for each of the vehicle side frames is shown in the following Table 1.

TABLE 1
Comparison of side frame strength parameters

| | | Rigidity- | Rigidity- |
|---|---|---|---|
| | | compression in the | compression in the |
| | Mass | vertical axis Z | horizontal axis X |
| Side frame | [kg] | [N/mm] | [N/mm] |
| Tubular profile | 5.16 | 77 | 83 |
| 32 mm/1.5 mm | | | |
| Rectangular profile | 5.4 | 176 | 188 |
| 45 mm/20 mm/1.2 mm | | | |
| Profile according to exemplary | 5.1 | 191 | 219 |
| arrangements, sheet thickness 0.8 mm | | | |

As shown in Table 1 the side frames made in accordance with the exemplary arrangements described herein, is lighter in weight than the exemplary side frames manufactured via prior art technology. The side frame of the exemplary arrangements made from a 0.8 mm thick wall sheets also demonstrated higher compressive rigidity along both the vertical axis Z and the horizontal axis X.

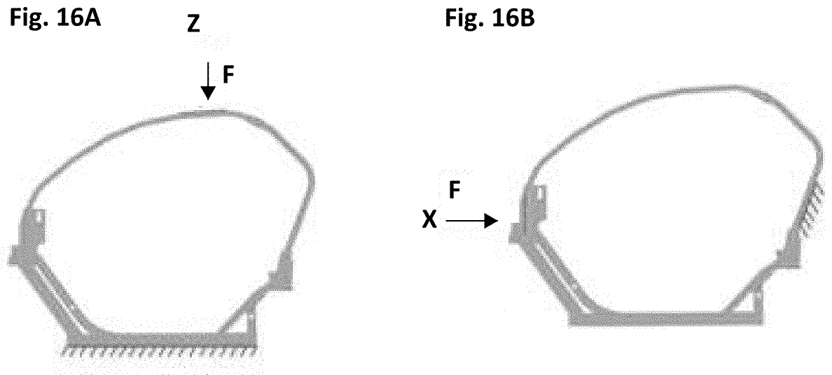

Similar comparative tests based on numerical calculations were performed for a vehicle side frame manufactured in accordance with the manufacturing methods including the frame components structures described herein, and compared to a vehicle side frame which was previously commercially produced. In this case the comparison was to vehicle side frame of a Renault® Twizy (Model 45 of 2015). This vehicle side frame from this commercial vehicle is shown in FIGS. 16A and 16B. In this example the side frame of the exemplary arrangements described herein was constructed having walls with a 1.2 mm transverse sheet thickness. Again as with the prior tests, compression tests were made of both arrangements along the vertical axis Z and the horizontal axis X. The results of the comparative testing are shown in Table 2.

TABLE 2
Comparison of side frame strength parameters

| | | Rigidity- | Rigidity- |
|---|---|---|---|
| | | compression | compression in |
| | Mass | in the vertical | the horizontal |
| Side frame | [kg] | axis Z [N/mm] | axis X [N/mm] |
| Prior art | 18.4 | 213 | 357 |
| Profile according to | 7.7 | 367 | 436 |
| exemplary arrangement, | | | |
| sheet thickness 1.2 mm | | | |

As shown in the above table, the vehicle side frame made in accordance with the exemplary methods described herein is lighter in weight than the prior art commercial vehicle side frame. Further the vehicle side frame made in accordance with the exemplary methods and including the exemplary frame components hereof (made using wall sheets having a transverse thickness of 1.2 mm), also demonstrated higher strength in the form of compressive rigidity both along the vertical axis Z and the horizontal axis X.

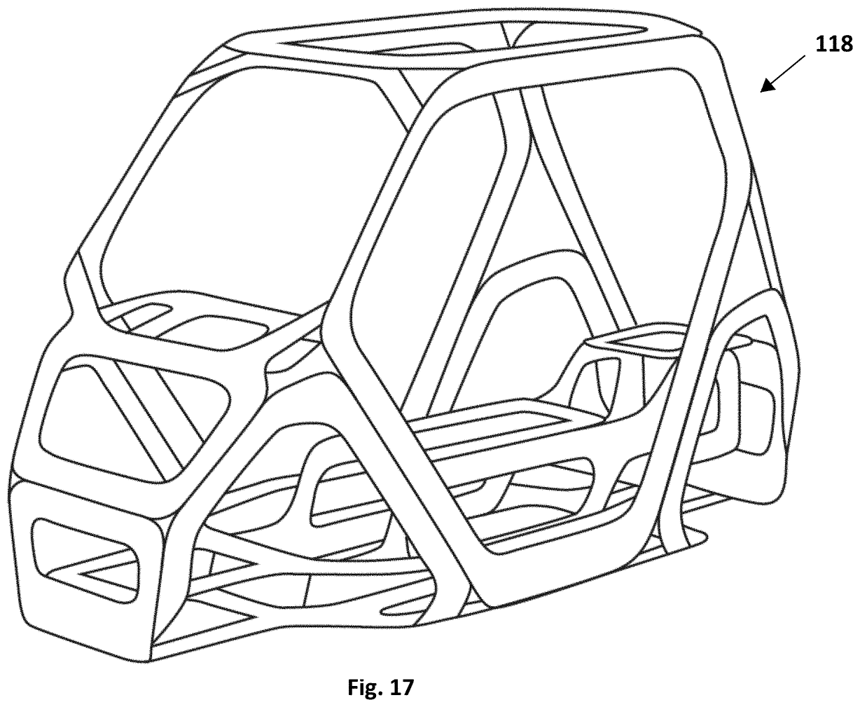

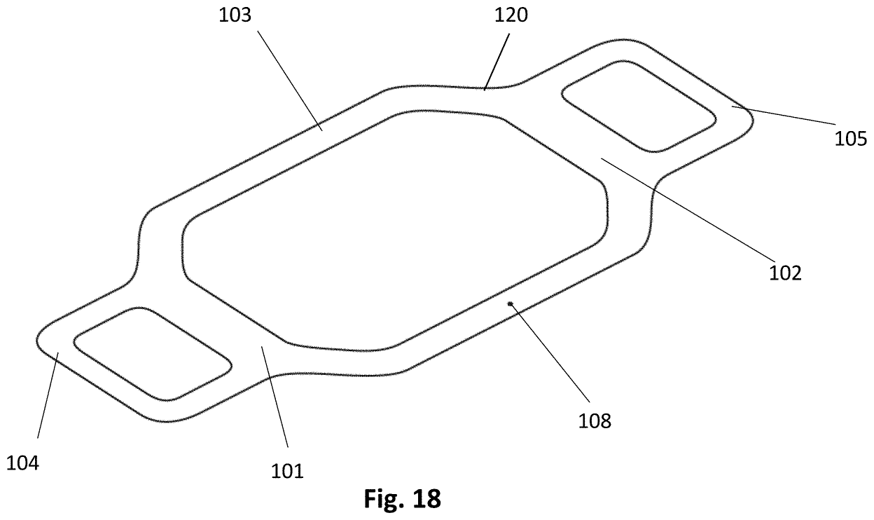

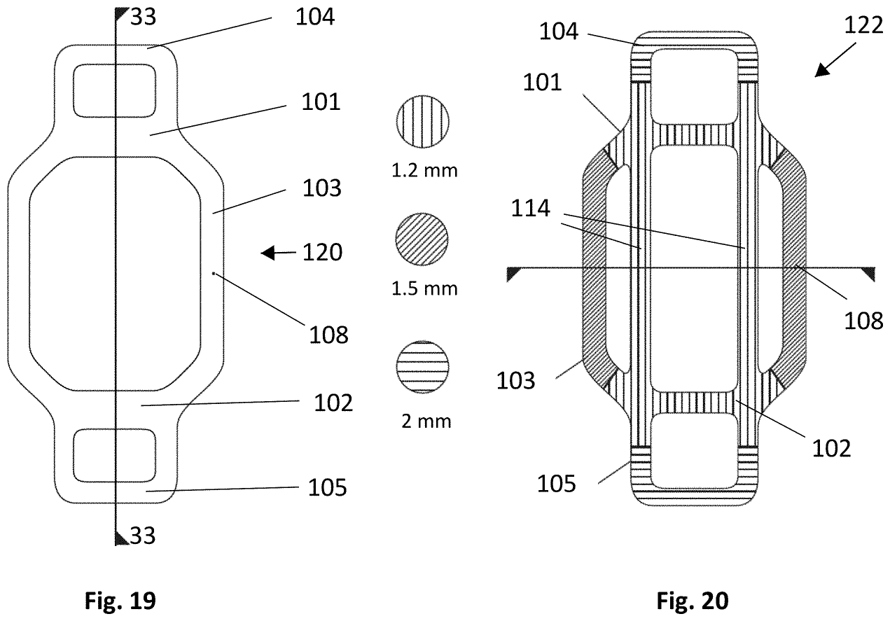

FIG. 17 shows a perspective view of an exemplary vehicle unibody frame 118 in which an exemplary floor member including frame components of exemplary arrangements are included. The exemplary floor member may alternatively be referred to herein as a platform or vehicle base. The exemplary floor member 120 that is integrated into frame 118 is shown in FIGS. 18 and 19.

As shown in FIG. 19 in a top plan view, the exemplary vehicle floor member 120 is a structure of a generally annular configuration. The exemplary vehicle floor member includes a front frame portion 101, and a rear frame portion 102 at an opposite end of the frame structure. The exemplary frame member further includes two side frame portions 103. Each of the side frame portions extend between the front frame portion 11 and the rear frame portion 102. This exemplary annular structure is configured to define a storage opening which in exemplary arrangements for electric vehicles may be a place for positioning electric vehicle batteries. Of course this approach is exemplary and in other arrangements other approaches may be used.

As shown in FIG. 19 in the exemplary frame member a front bumper portion 104 extends from the front frame portion 101. A rear bumper portion 105 extends from the rear frame portion 102. In this exemplary arrangement both the front bumper portion 104 and the rear bumper portion 105 comprise annular structures that define generally rectangular inner openings. Although in this exemplary arrangement the front bumper portion 104 and the rear bumper portion 105 are substantially identical in terms of their construction and geometry, it should be understood that in other exemplary arrangements the front and rear bumper portions may have different configurations or alternatively may not be included in the vehicle floor member.

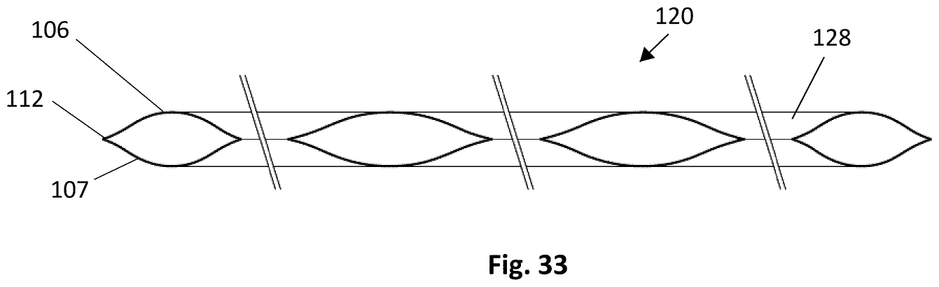

In the exemplary arrangement the components of the floor member are initially fabricated and connected to provide a preform which has an integral frame component comprised of a pair of walls, each of which comprise at least one metal sheet. As in the previously described arrangements the steel sheets define a first or inner wall 106 and a second or outer wall 107. A cross-sectional view of an exemplary floor member 120 is shown for example in FIG. 33.

As described in connection with the vehicle structures including the vehicle side frames, some exemplary floor members may include different transverse sheet wall thicknesses in different regions of the floor member. Similarly different regions of exemplary floor members may comprise different types of metal sheets as well as other materials. Further as can be appreciated in other exemplary arrangements other features like those previously described may be utilized in connection with providing frame components that are integrated in the exemplary floor members.

In some exemplary arrangements the first wall 106 and the second wall 107 are arranged in alignment with respect to each other. The sheets are joined in operative connection and bound an interior gap 128 which is hermetically sealed. As in the previously discussed arrangements the gap initially comprises an empty space between the inside's surface of the walls of the floor member. In exemplary arrangements a fluid connector 108 is arranged in connection with one of the walls. The exemplary fluid connector 108 enables pressurized fluid to be introduced into the interior gap 128 between the walls 106, 107 of the floor member.

As in the previously discussed arrangements the fluid connector 108 may be configured to enable the delivery of pressurized fluid such as a liquid or gas through the respective wall of the frame member and into the interior gap. The pressurized fluid may be introduced via a supply connector from an external source of pressurized fluid. Further as previously discussed the exemplary fluid connector may be in operative connection with a valve structure such as a check valve which prevents the release of fluid pressure from the interior gap. Alternatively the fluid connector may be in operative connection with the relief valve which enables fluid above a particular pressure to escape. Of course it should be understood that these approaches are exemplary and in other arrangements other approaches may be used.

In an exemplary manufacturing method of making the exemplary floor member 120, the outer edges and inner edges of the respective sheets are operatively connected in a manner that provides a hermetically sealed interior gap 128 between the walls. This is done through the formation of a seal 122. In exemplary arrangements the seal may be formed at the edges of the walls by joining the circumferential edges of the walls together via welding or other methods. Further as previously discussed other joining in sealing methods may be used to assure the formation of a leakproof hermetically sealed interior gap between the walls of the floor member. For example in other exemplary arrangements pressure welding, soldering, gluing, bending, pressing, coating, caulking or other joining and sealing methods may be utilized.

In the exemplary methods of manufacture of a vehicle floor member after the preform is produced and the walls have been operatively connected so that the hermetically sealed interior gap 128 has been formed, pressurized fluid is introduced into the gap through the fluid connector 108. In some exemplary arrangements the pressurized fluid may include air provided by a compressor or other suitable source of elevated air pressure. Of course it should be understood that other types of pressurized fluids may be used. These may include for example gases such as nitrogen containing gases or inert gases. Other pressurized fluids may include water-based fluids, petroleum-based fluids, non-Newtonian fluids, foams, fluid cement, fluid concrete, fluid plastics or other materials. In some exemplary arrangements the pressurized fluid may include a one, two or three component foam (for example flex 140 type), flowable natural material such as a liquid rubber or other suitable materials. Further as can be appreciated in exemplary arrangements in which permanent deformation of the walls or other structures of the preform is to be accomplished, a generally incompressible fluid or fluid with less compressibility is advantageously utilized to more effectively control the speed, uniformity and amount of deformation.

In some exemplary arrangements the introduction of the pressurized fluid into the sealed interior gap 128 between the walls is operative to permanently deform the metal sheets of which the exemplary walls are made. For example in some exemplary arrangements the exemplary metal sheets may be deformed through the introduction of the pressurized fluid to provide deformation of the respective walls such as is shown in FIG. 33. For example as shown by the inner portions of the deformed walls bounding the sealed interior gap structures, such structures may be deformed in a controlled manner to achieve desired strength and other properties.

Further in exemplary arrangements of the floor member 120 the geometrical dimensions of the front bumper portion 104 in connection with the front frame portion 101, and the rear frame portion 102 and the rear bumper portion 104 are selected by the requirements for rigidity and strength of such areas. For example in some exemplary arrangements such portions of the frame member may be constructed in a manner suitable for providing controlled deformation zones that serve to absorb energy and protect the occupants of the vehicle in a collision. Further as previously discussed the configurations of frame members may have different wall thicknesses in different regions as well as different structures to provide for the desired properties. Further the fluid introduced into the sealed interior gap may further provide properties of enhanced strength of the different materials and structures as well as other properties that are desirable in the use and operation of the vehicle.

In exemplary manufacturing methods the introduction of the pressurized fluid into the sealed interior gap 128 is done at room temperatures. However in other exemplary arrangements other manufacturing environments may be utilized including carrying out the process at higher temperatures in which the materials utilized may have different properties.

In some exemplary arrangements the manufacture of the exemplary floor member is carried out at a process temperature of approximately 20° C. The pressurized fluid introduced into the sealed interior gap comprises air which is delivered at a pressure of about 2 bars. In exemplary arrangements the pressure hold time provided is approximately 30 seconds and the period during which deformation is carried out was approximately one minute which is required to equalize the pressure throughout the sealed interior gap of the preform. Further the exemplary deformation time for deformation of the wall structures is approximately 1.5 minutes.

Of course it should be understood that this particular structure and manufacturing method is exemplary and in other arrangements other approaches may be used.

A further exemplary arrangement of a vehicle floor member 122 is shown in FIG. 20. In this exemplary arrangement the vehicle floor member comprises a structure that includes frame components of exemplary arrangements and is generally similar to the structure of vehicle floor member 120 except as otherwise specifically indicated.

In this exemplary arrangement the vehicle floor member 122 includes opposed walls that do not have a uniform transverse thickness across the entire vehicle floor member. Rather in this exemplary arrangement the walls have different regions of various transverse thicknesses in a patchwork structure as desired to impart different properties to different areas of the vehicle floor member.

As shown for example in FIG. 20 the exemplary vehicle floor member 122 is comprised of three wall regions of each wall bounding the frame component having different transverse wall thicknesses. As indicated in this exemplary arrangement the regions or areas indicated by the horizontal hash lines have a transverse wall thickness of 2 mm. These thicknesses extend in the forward area of the front bumper portion 104 and the rear area of the rear bumper portion 105. A second region having a transverse wall thickness of 1.5 mm is indicated by the diagonal lines. Regions having this wall thickness include the side frame portions. A third transverse wall thickness indicated by the vertical lines include the inner portions of the front frame portion 11 and the rear frame portion 102 as well as the frame longitudinal ribs 114.

As a result in this exemplary arrangement the inner wall 106 and the outer wall 107 of the exemplary frame components included in the vehicle floor member 122 comprise metal sheets that have various regions with different transverse thicknesses. The various thicknesses of the walls of the exemplary arrangement enables the floor member to have desired functional characteristics including desired strength and rigidity in the regions having the increased sheet thicknesses. In exemplary arrangements the different thicknesses of the different regions of the walls 106, 107 may be achieved through different methods. These may include for example press forming, rolling, joining together multiple sheets of different thicknesses and other methods for providing different transverse thicknesses as desired in the different regions. Of course these approaches are exemplary and in other arrangements other approaches may be used.

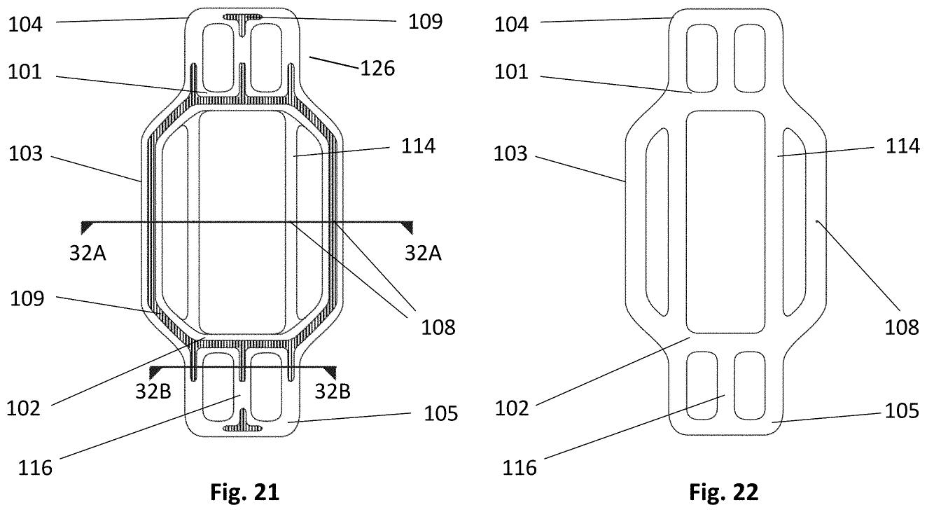

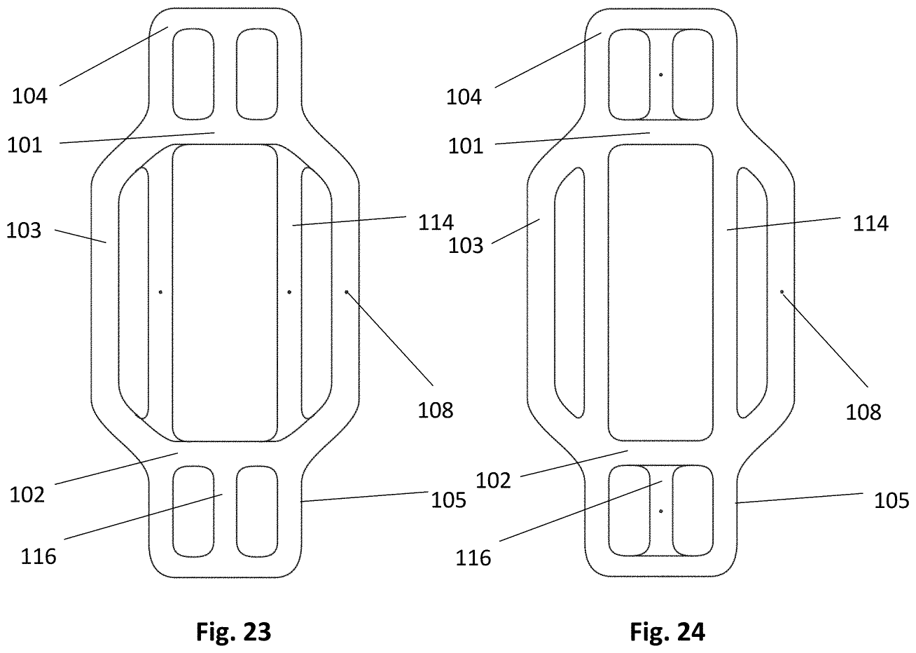

Further in the exemplary arrangement of the vehicle floor member 122 the frame longitudinal ribs 114 extend operatively between the front frame portion 101 and the rear frame portion 102. In the exemplary arrangement the longitudinal ribs 114 divide the generally annular storage opening. The exemplary longitudinal ribs extend substantially parallel with respect to the corresponding side frame portions 103 that in this exemplary arrangement are integrated therewith. However it should be noted that in other arrangements longitudinal ribs similar to ribs 114 may comprise structures that are assembled independent from the remaining portions of the vehicle floor member. In such arrangements the longitudinal ribs may be structures that are mounted in fixed engagement to respective regions of the front frame portion 101 and the rear frame portion 102 of the floor member. Such independently mounted longitudinal ribs are shown for example in FIGS. 21, 23 and 25. In exemplary arrangements longitudinal rib structures may be mounted in attached fixed connection through various methods including pressure welding, welding, bolting, fastening, crimping, gluing and other attaching methods. Further it should be understood that exemplary arrangements are not limited to a particular number of longitudinal ribs. The number of longitudinal ribs may include different numbers and configurations of ribs as may be desirable for achieving the desired configuration and strength properties of the particular floor member. For example as shown in FIG. 26 and floor member is shown including three frame longitudinal ribs.

In those exemplary arrangements in which the longitudinal ribs are assembled as a member separate from the other portions of the floor member, the longitudinal ribs may be a member which includes one or more frame components which provide the desired properties of the exemplary arrangements described herein. In such cases such longitudinal frame members may include wall structures, hermetically sealed interior gap structures, pocket structures and fluid connectors for introducing fluid under pressure into the sealed interior gap areas. Of course it should be understood that these approaches are exemplary and in other arrangements other approaches may be used.

Exemplary arrangements may also include floor members which have different regions that are comprised of different materials as well as different transverse wall thicknesses. For example FIG. 26 shows a floor member 124 that is comprised of three different materials. In exemplary arrangements the different sheet materials which make up the floor member 124 are comprised of different materials providing a material patchwork structure. As represented in FIG. 26 the floor member is comprised of different materials which in this exemplary arrangement include wall members comprised of at least one stainless steel sheet, at least one carbon steel sheet, and at least one black steel sheet. In this exemplary arrangement the region comprised of the first material (material 01) is indicated by the diagonal lines and includes the front bumper portion 104, the rear bumper portion 105 and the side frame portions 103. In this exemplary arrangement the regions comprised of the second material (material 02) is indicated with the checkered lines and includes the central frame longitudinal rib 114 and the central portion of the front frame portion 11 and the central portion of the rear frame portion 12. The outer frame longitudinal ribs 114 are comprised of the third material (material 03) as indicated by the dots thereon. Of course it should be understood that this approach is exemplary and in other arrangements other materials and other respective regions in which the materials are utilized may be provided. Further it should be understood that in other exemplary arrangements the walls of the floor member may be comprised of multiple overlying sheets of different materials joined together by suitable methods to provide the desired frame member properties.

In the exemplary arrangement shown in FIG. 26 the inner wall 106 and the outer wall 107 are comprised of metal sheets which have varying materials in the individual regions of the vehicle floor member 124, as well as the preform structure which is produced as the starting structure for purposes of the manufacturing process. As a result of the use of the material patchwork type structure, the vehicle floor member produced is given desired functional characteristics. These are manifested in the increased strength and rigidity in the regions in which a material which has increased properties for strength such as rigidity and resistance to deformation is included. Further in the exemplary arrangement the structure of the inner wall 106 and the outer wall 107 is an integrated structure that includes regions comprised of different materials. Of course it should be understood that the joining of the different materials may be accomplished in different ways which include for example the joining of the materials through welding, pressure welding, soldering, gluing, fusing or other suitable methods depending on the materials involved.

Of course it should be understood that these approaches are exemplary and in other arrangements other approaches may be used.

A further exemplary arrangement of a vehicle floor member 126 is shown in FIG. 21. This exemplary vehicle floor member includes features of the floor members previously discussed and is substantially similar thereto except as specifically described.

Unlike the exemplary vehicle floor members 120 and 124, vehicle floor member 126 includes a reinforcing pillar 160. The exemplary reinforcing pillar 116 extends in the region of the front bumper portion 104 and/or the rear bumper portion 105. In this exemplary arrangement a front reinforcing pillar extends across the generally annular front bumper portion from the outer portion of the front bumper portion 104 to the front frame portion 101. Further in this exemplary arrangement a second or rear reinforcing pillar 116 extends across the generally annular rear bumper portion 105. The exemplary second reinforcing pillar 116 extends from the outer portion of the rear bumper portion 105 to the rear frame portion 102. FIGS. 22, 23 and 20 also show exemplary arrangements of reinforcing pillars included in the bumper portions of a frame member. However it should be understood that these arrangements of reinforcing pillars are exemplary and in other exemplary arrangements the number and direction of reinforcing pillars may be different.

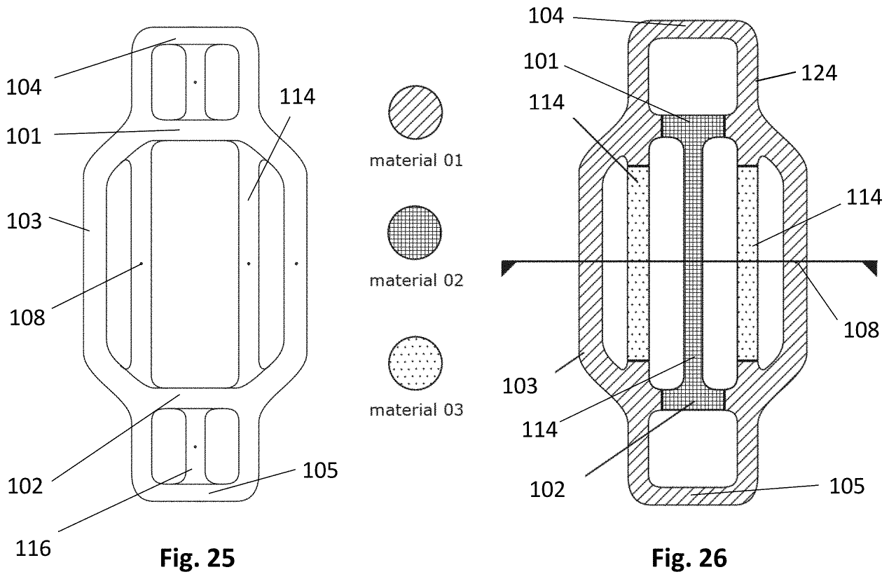

In other arrangements the bumper portions and reinforcing pillars may have different geometries. For example in other exemplary arrangements bumper portions may have different configurations and reinforcing pillars in such portions may have other structures. Also in arrangements where the bumper portions are generally annular, reinforcing pillars may include pillars that extend in different angular configurations or other directions across the annular structures. Further in some exemplary arrangements the reinforcing pillars in the bumper portions may be structures that are assembled independent from the remaining portions of the vehicle floor member. For example in some arrangements reinforcing members may be mounted to respective regions of the front frame portion and/or the outer portion of the front bumper portion 104 or the rear frame portion 102 and the outer portion of the rear bumper portion. Such arrangements are shown for example in the floor members of FIGS. 24 and 25. It should be understood that numerous different approaches may be used in exemplary arrangements for connecting reinforcing pillars and the remaining structure of the floor members. Connecting methods such as welding, pressure welding, bolting, crimping, gluing or other fastening methods may be used. Further it should be understood that different numbers and configurations of reinforcing pillars may be used in different arrangements.

In some exemplary arrangements where reinforcing pillars 116 are assembled as a separate member and later connected to the floor member, the reinforcing pillar may include one or more frame components like those described herein which provide desired properties for the reinforcing pillar. In such exemplary arrangements the reinforcing pillar may include frame components of the type described herein as well as one or more fluid connectors which are operative to deliver pressurized fluid into the sealed interior gap of the member.

The exemplary floor member 126 of FIG. 21 includes walls with flattened regions 109. In exemplary arrangements the flattened regions are provided to achieve a desired configuration of the frame component. The desired configuration may be useful for purposes of providing desired strength and other properties as well as for providing mounting areas for vehicle components or for other purposes.

In exemplary manufacturing methods for producing vehicle floor member 126 in the step of introducing the pressurized fluid into the sealed interior gap of the floor member preform, the walls of the preform are positioned between pressure plates 113 which may be of the type previously discussed. In exemplary arrangements the pressure plates are configured so that the walls 106, 107 of the preform are in contact with the pressure plates such as is shown in FIG. 4. In exemplary arrangements the walls deform outward and conform to contours of the contacting services of the adjacent pressure plates. In some exemplary arrangements the pressure plates may include the working elements of the mechanical press. Controlled force applied to the pressure plates, particularly in the direction toward the vehicle floor member preform, provides an opposing force against the walls that control the final position and configuration of the wall after permanent deformation. By maintaining the vehicle floor member preform between the pressure plates 113 during the introduction of pressurized fluid to the sealed interior gap, flattened regions 109 are produced in the areas where the pressure plates are applied.

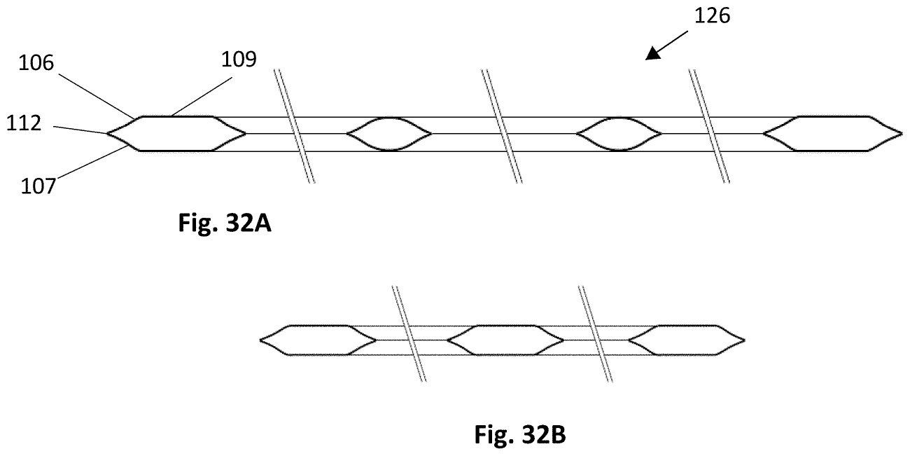

FIG. 32A shows an exemplary cross-sectional view of the vehicle floor member 126 taken along line 32A-32A in FIG. 21. FIG. 32A shows the exemplary vehicle floor member with regions formed in a free manner, without the use of pressure plates 113 in engagement with inward members 114. The outer members of the side frame portions 103 are deformed in a controlled manner using pressure plates 113 to produce the flattened portions 109.

FIG. 32B shows a cross-sectional view taken along line 32B-32B in FIG. 21. In this exemplary cross-sectional view each of the frame components is shown deformed in a manner where the deformation is controlled through the use of pressure plates 113. As a result the walls of these frame components include the flattened portions 109. Of course it should be understood that these approaches and configurations are exemplary and in other arrangements other approaches may be used.

The exemplary method of manufacturing the floor member 126 including the exemplary frame components may be accomplished using equipment like that shown in FIG. 5, which in this case would correspond to only half of the vehicle floor member as shown. In this exemplary arrangement one vehicle floor member portion (the one shown to the left in FIG. 5) is not in contact with the pressure plates 113 and is deformed in a free manner, while the frame component shown to the right in the Figure has walls bounding the sealed interior gap in contact with the pressure plates. Thus in these exemplary arrangements it is possible to provide desired configurations and locations for mounting areas for vehicle functional equipment as well as to locally modify the characteristics of the vehicle floor member for strength properties such as rigidity of the structure and to form controlled deformation zones.

Of course it should be understood that in other arrangements other approaches may be used such as those previously discussed in connection with vehicle floor member 120 shown in FIG. 33 in which the walls of the frame component are permanently deformed in a free manner, and without the use of pressure plates to determine the wall configuration in at least some areas. Of course it should be understood that various arrangements of different frame components may include different transverse wall thicknesses, different wall materials, different configurations after deformation, different fluid materials that remain within the sealed interior gap area after production steps and other features that provide the desired properties of the vehicle floor member.

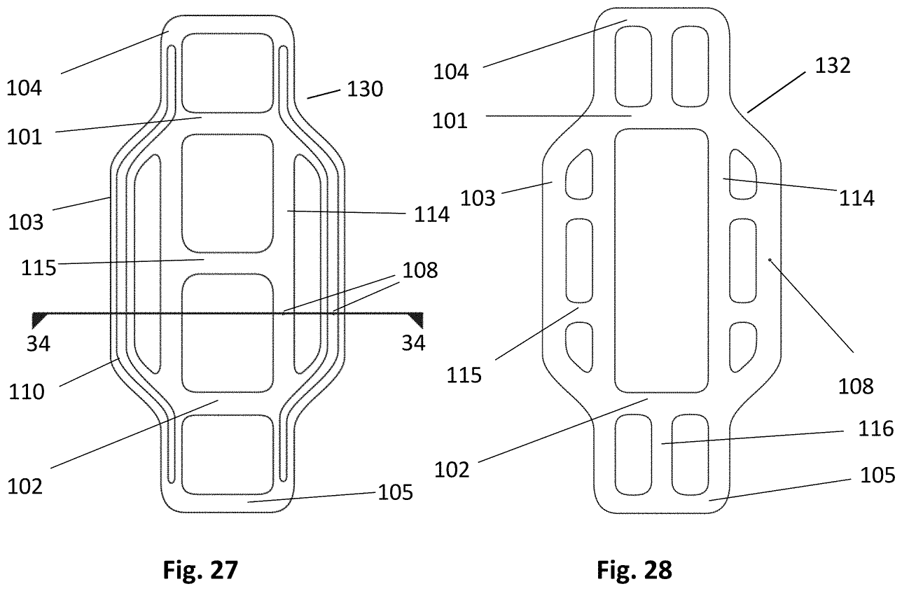

FIG. 27 shows an alternative arrangement of a vehicle floor member 130 that includes at least one frame component of an exemplary arrangement. FIG. 27 is a top view of the vehicle floor member without the outer wall 107. This view shows the structures of the frame components included in this floor member more clearly.

In this exemplary arrangement the vehicle floor member 130 is generally similar to the vehicle floor members 120, 122, 124 and 126 previously discussed, except as otherwise described. Unlike the prior arrangements floor member 130 additionally comprises a frame transverse rib 115. The exemplary frame transverse rib extends between the frame longitudinal ribs 114 that extend adjacent to the side frame portions 103. The exemplary frame transverse rib 115 extends substantially perpendicular to the frame longitudinal ribs 114 in which it is in operative fixed connection. In this exemplary arrangement the frame transverse rib is an integrated structure with the remainder of the vehicle floor member. However it should be understood that in other arrangements the transverse rib 115 may be produced independently from the other structures of the vehicle floor member. In such arrangements the frame transverse rib may be joined in operative connection with the structures of the vehicle floor member through connecting technology such as welding, pressure welding bolting, gluing or other joining methods. Of course it should be understood that these approaches are exemplary and in other arrangements other approaches may be used.

Other floor member configurations may include different numbers and configurations of transverse ribs 115. For example FIG. 28 shows a floor member 132 that includes four transverse ribs. In this exemplary arrangement the floor transverse ribs extend between the side frame portion 103 and the adjacent frame longitudinal rib 114 that is immediately adjacent thereto. It should further be understood that in some exemplary arrangements the transverse ribs such as those of vehicle floor member 132 may be integrally formed with the vehicle floor member preform or may comprise separately produced structures that are joined with the vehicle floor member through joining methods such as those previously discussed. Further in exemplary arrangements one or more of the transverse ribs that are formed as separate structures may include one or more frame components of the type previously discussed, which provide selected additional strength or other properties. In such cases the transverse rib members include fluid connectors suitable for introducing the pressurized fluid into the sealed interior gaps thereof. Of course it should be understood that these approaches are exemplary and numerous different configurations and structures may be utilized.

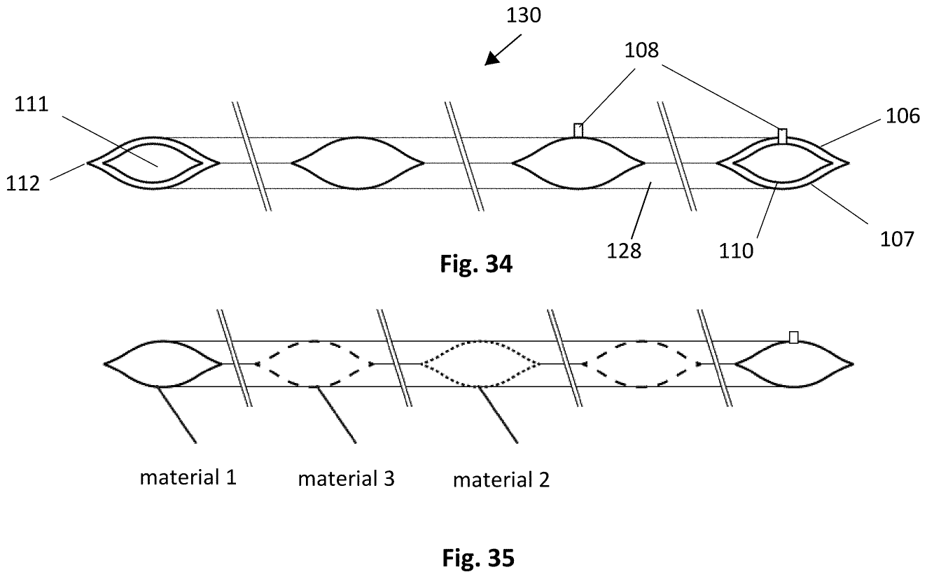

FIG. 34 shows a cross-sectional view of vehicle floor member 134 taken along line 34-34 in FIG. 27. In this exemplary arrangement the vehicle floor member includes frame components that include hermetically sealed pockets 110. In this exemplary arrangement the inner pockets 110 are arranged in the sealed interior gap 128 that extends between the walls 106 and 107. Each pocket comprises a leakproof hermetic structure that is in fluid communication with the fluid connector 108. The fluid connector delivers the pressurized fluid through one of the wall 106 or 107 of the frame component. In exemplary arrangements pockets may be formed in a manner similar to the walls of the frame component, that is formed of metal sheets that are connected with one another and sealed in fluid tight engagement at the edges thereof. In alternative arrangements the pockets 110 may be formed from other materials and using other approaches. This may include for example having the pockets comprised of generally flexible materials such as textiles.

In the exemplary arrangement of the floor member 130, there are two frame components that include inner pockets 110. The pockets 110 of the exemplary arrangement extends partially through the front bumper portion 104, the side frame portion 103 and partially through the rear bumper portion 105. A further frame component of an exemplary arrangement is positioned on the opposite side of the vehicle floor member and is a mirror image of the frame component and pocket.

In exemplary arrangements the frame components used in the vehicle floor member 130 may be utilized to produce different properties and results. In some exemplary arrangements the inner pocket 110 shown on the right in FIG. 34 may be comprised of a sheet of carbon steel while the remainder of the frame component and vehicle floor structure is made of stainless steel. In the exemplary arrangement carbon steel has a greater hardness than the stainless steel. Therefore the inner pocket 110 is an element which increases the strength of the frame component structure and vehicle floor member. Additionally the exemplary inner pocket 110 is deformed during the manufacturing process by fluid such as pressurized air, that is introduced in the pocket interior area after the frame component has already been permanently deformed through the use of fluid pressure. This exemplary approach allows additional local deformation to be made in the already formed frame component which allows the geometry of the vehicle floor member to be adjusted to a desired final shape.

In the exemplary arrangement the inner pocket 110 shown on the left in FIG. 34 is comprised of a flexible textile material such as for example Kevlar®. In this exemplary pocket of the frame component, a filler 111 is positioned within the pocket. In the exemplary arrangement the filler 111 comprises a non-Newtonian fluid which allows the formation of selectively adjusted shock absorbing zones. For example in exemplary arrangements the inner pocket 110 which holds the non-Newtonian fluid may be initially produced as a separate structure that is introduced into the vehicle member preform. Alternatively in the manufacturing process the inner pocket 110 may be filled with the non-Newtonian fluid after the vehicle floor member has been formed, in which arrangement the inner pocket is filled with the non-Newtonian fluid through the fluid connector 108 that is connected therewith.

Of course it should be understood that this arrangement is exemplary and in other arrangements the sealed interior gap of the frame component and/or the pockets 110 may be comprised of different materials and/or be filed with different fillers. This is done to provide the desired properties. For example in some arrangements filler materials may provide added strength to the frame components. In other arrangements the configuration of the frame structures and filler materials may provide soundproofing or antivibration properties. Filler materials may be numerous different types of materials including without limitation the materials that have been previously discussed herein.

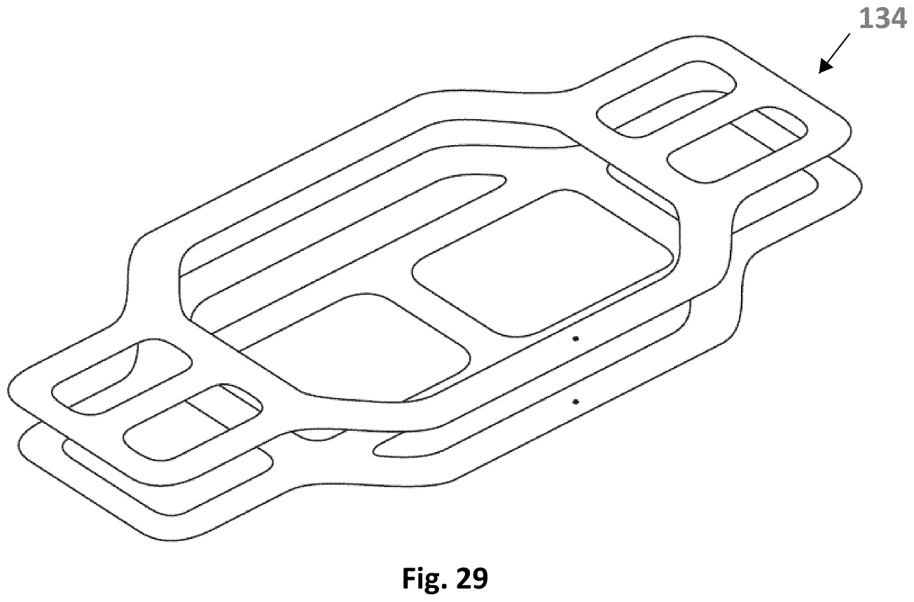

FIG. 29 shows an exemplary arrangement of the vehicle floor system generally indicated 134. In this exemplary arrangement the vehicle floor system comprises two vehicle floor members of the types previously discussed, arranged in stacked overlying engagement. In the exemplary arrangement the vehicle floor members are operatively engaged and held in a respective overlying aligned relation. In the exemplary arrangement shown in FIG. 29 the lower vehicle floor member is of the type of vehicle floor member 122 shown in FIG. 20, while the upper vehicle floor member is of the type of vehicle floor member 126 shown in FIG. 21. Of course it should be understood that this arrangement is exemplary and in other arrangements other types and numbers of vehicle floor members may be used in a desired vehicle floor system.

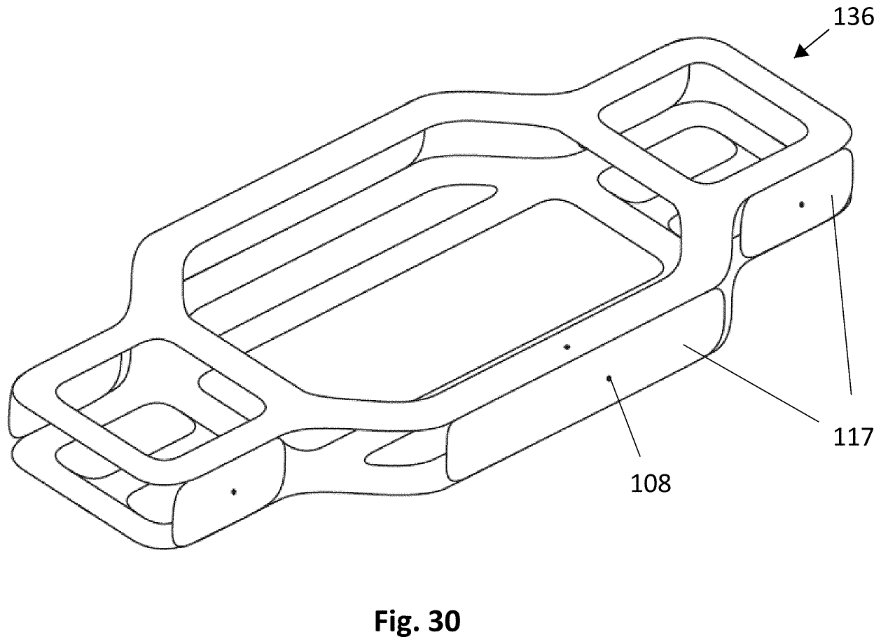

FIG. 30 shows a further alternative arrangement of a vehicle floor system generally indicated 136. In this exemplary arrangement a lower vehicle floor member similar to the vehicle floor member shown in FIG. 24 is arranged below a vehicle floor member similar to floor member 120 shown in FIG. 19. Unlike the vehicle floor system 134 shown in FIG. 29 in this exemplary arrangement the floor system includes generally vertically extending side plates 117. The exemplary side plates 117 operatively connect the corresponding vehicle floor members. The exemplary side plates are operative to ensure that the vehicle floor members are kept apart at a defined distance with respect to one another. As shown in FIG. 30 the exemplary vehicle floor system 136 includes six side plates 117. Two of the side plates in this exemplary arrangement are located on opposite sides of the corresponding front bumper portions 104. Side plates are also located in this arrangement on opposed sides of the corresponding rear bumper portions 105. The side frame portions 103 are also connected by side plates 117.

In this exemplary arrangement each of the side plates 117 includes at least one frame component of the types previously described which provide increased strength and/or other desirable properties for the vehicle frame structure. In the exemplary arrangement the exemplary frame components include first and second side walls which bound a hermetically sealed interior gap in a manner like that previously discussed. Further in exemplary arrangements the side plates may further include frame components including internal pockets within the sealed interior gap. In such exemplary arrangements pressurized fluid is introduced into the sealed interior gap through fluid connectors 108 and through one of the first and second walls. Such delivered pressurized fluid may be operative to provide desired permanent deformation of frame component structures and/or the delivered fluid may have desirable properties for purposes of providing a vehicle frame of the type desired.

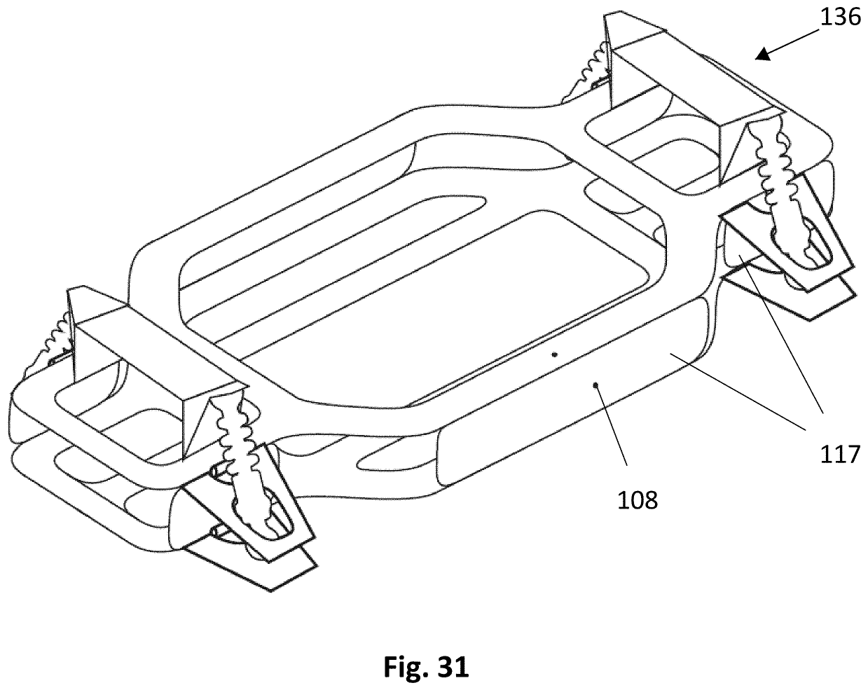

As can be appreciated the exemplary vehicle frame system 136 may be attached to other structures such as a suspension arrangement as shown in FIG. 31 for purposes of providing a suitable vehicle platform for the particular type of vehicle desired. Of course it should be understood that these arrangements are exemplary and in other arrangements other approaches may be used.

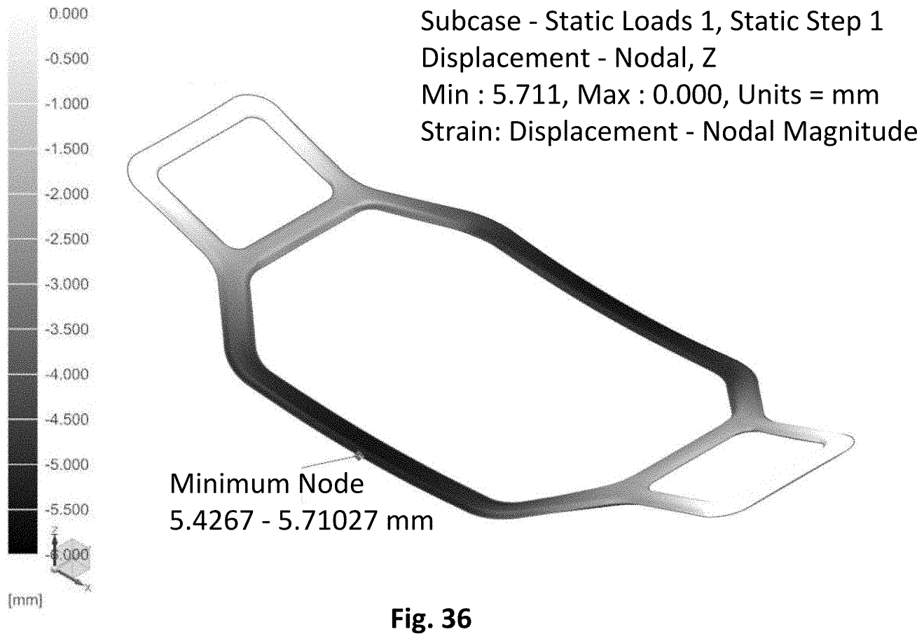

Certain vehicle floor members of the exemplary arrangements were subjected to comparative tests with vehicle floor members manufactured using prior art technologies. FIGS. 36-39 show displacement maps for exemplary vehicle floor members of the different types. The displacement maps show displacement in the Z axis in the case of bending and rotation along the X axis in the case of torsion for the vehicle floor members in different load states. The exemplary analysis was performed for the cases of twisting and bending of the vehicle floor members. Identical boundary conditions were maintained for all the tests.

In the case of twisting all the floor members were secured in the rear portion (that is in the center of the rear bumper portion 105). The front of the floor member was twisted by an angle equal to 1°. In the case of bending, all frames were supported in two points (in the center of the front bumper portion 104 and the rear bumper portion 105). A force corresponding to a mass of 100 N was applied in the central portion in the center of the side frame portion 103. In the stress distribution maps the legend for the corresponding load cases (twisting/bending) is presented in an identical scale. The values of rotation of twisting, expressed in degrees, correspond to the loading with the twisting moment M=100 Nm. The material used in the simulations was steel, having a Young's modulus E=206.94 GPa, and a Poisson's ratio of v=0.288 and a density p=7829 kg/m³.

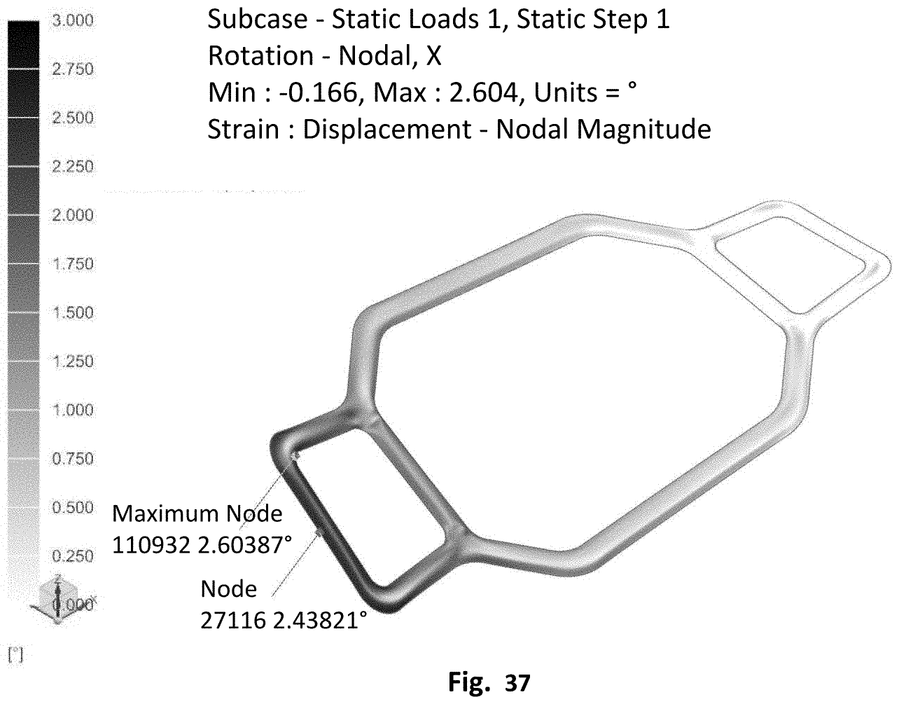

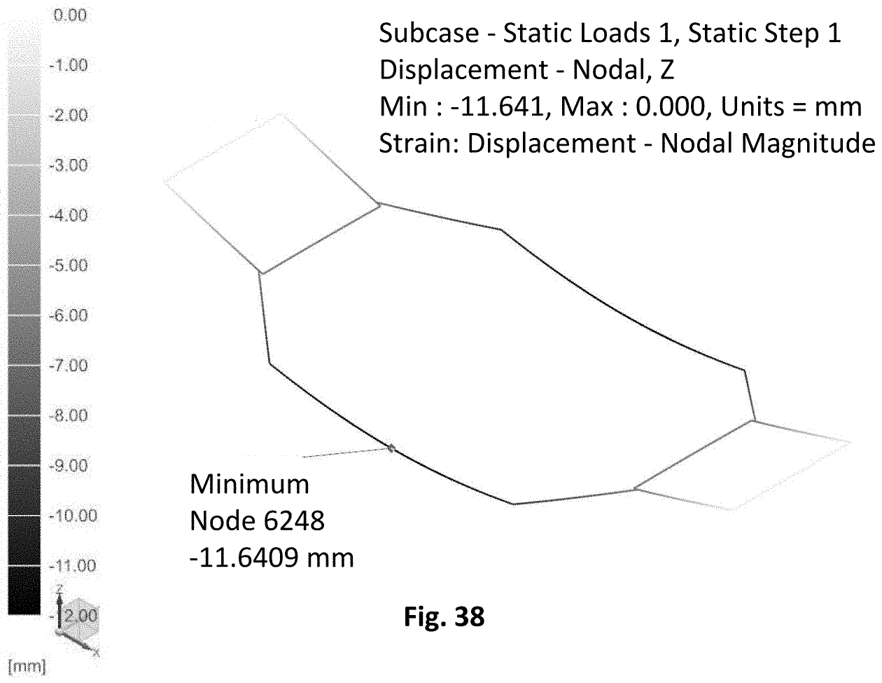

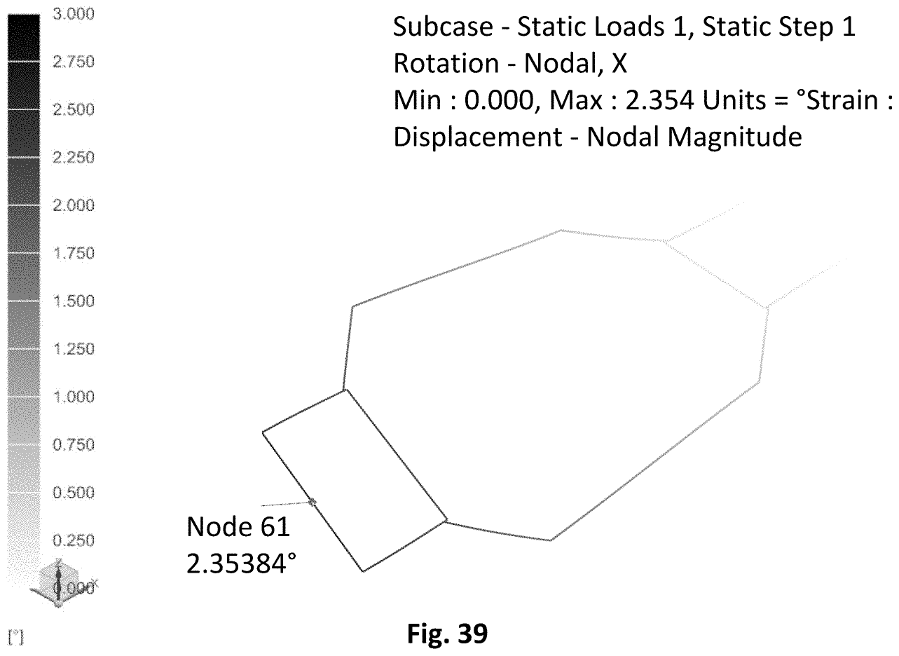

FIGS. 36 and 37 show displacement maps for a floor member according to exemplary arrangements which include frame components of the type previously described and that were manufactured in accordance with the exemplary manufacturing methods described herein. FIGS. 38 and 39 are displacement maps for a floor member manufactured using prior art technology with classic rectangular profiles.

The calculated strength parameters are presented in Table 3 below.

TABLE 3
Comparison of vehicle floor member strength parameters

| | | | | |
|---|---|---|---|---|
| floor | Profile | rectangular | rectangular | rectangular |
| member | cross section | 50 × 20 × 1.2 | 60 × 20 × 1.5 | 70 × 20 × 1.5 |
| made | torsional rigidity | 42.5 | 62.8 | 74.4 |
| from | [Nm/°] | | | |
| standard | bending rigidity | 8.6 | 12.4 | 14.3 |
| profiles | [N/mm] | | | |
| | Mass [kg] | 11.1 | 15.7 | 17.8 |
| | Light Weight | 67.0 | 64.1 | 61.3 |
| | Index | | | |
| Floor | Sheet thickness | 0.8 | 1.0 | 1.2 |
| member | [mm] | | | |
| made | Torsional rigidity | 41.0 | 59.0 | 79.2 |
| of | [Nm/°] | | | |
| exemplary | Bending rigidity | 17.5 | 24.5 | 31.9 |
| arrangement | [N/mm] | | | |
| | Mass [kg] | 11.7 | 14.6 | 17.6 |
| | Light Weight | 73.2 | 63.5 | 57.0 |
| | Index | | | |

As shown in Table 3 the floor member made in accordance with the exemplary arrangements described herein is lighter in weight than the floor member made in a conventional prior art manner from standard profiles. In the exemplary arrangement in which the sheet thickness of the walls of the floor member was 1.0 mm, the compared conventional floor member had the 60×20×1.5 mm rectangular profile. For the exemplary arrangement in which the sheet thickness of the walls of the floor member was 1.2 mm the compared conventional floor member had the 70×20×1.5 mm rectangular profile.

As demonstrated in Table 3 the floor members of the exemplary arrangements described herein generally provide greater strength and lighter weight. Of course it should be understood that these results are exemplary and in other arrangements even more favorable comparisons may be achieved by using different materials, transverse wall thicknesses, wall configurations and/or fluids within the sealed interior gaps of the frame components.

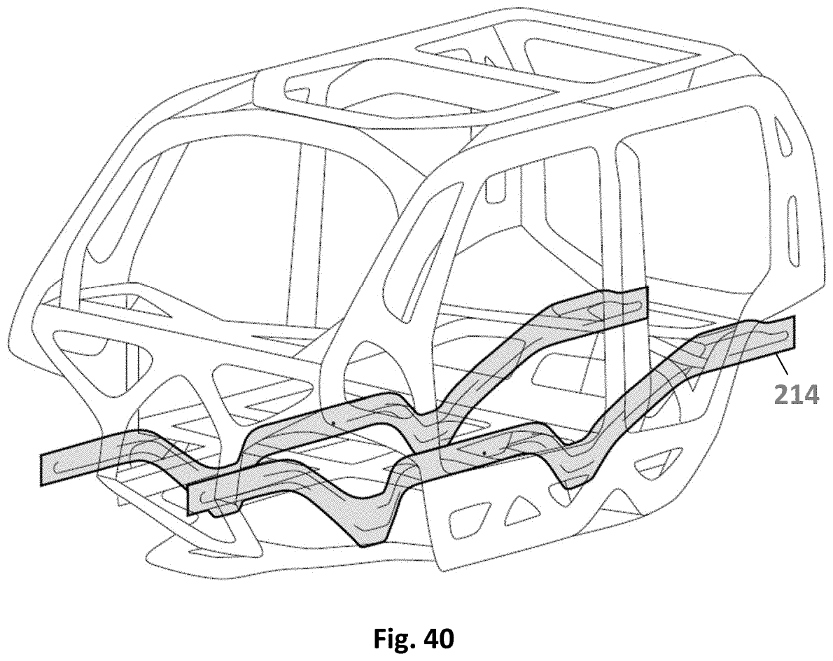

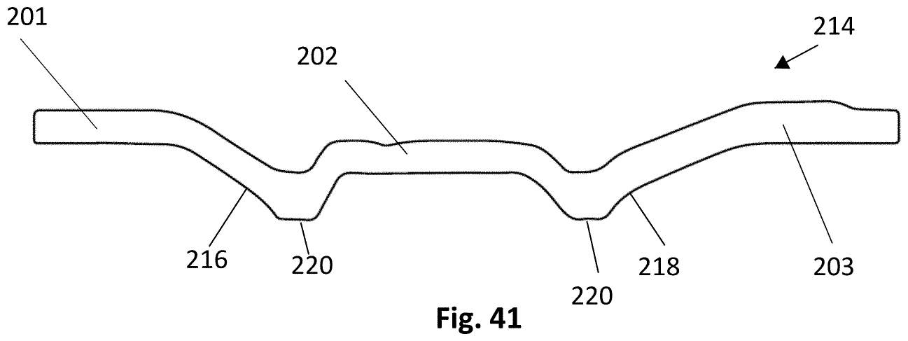

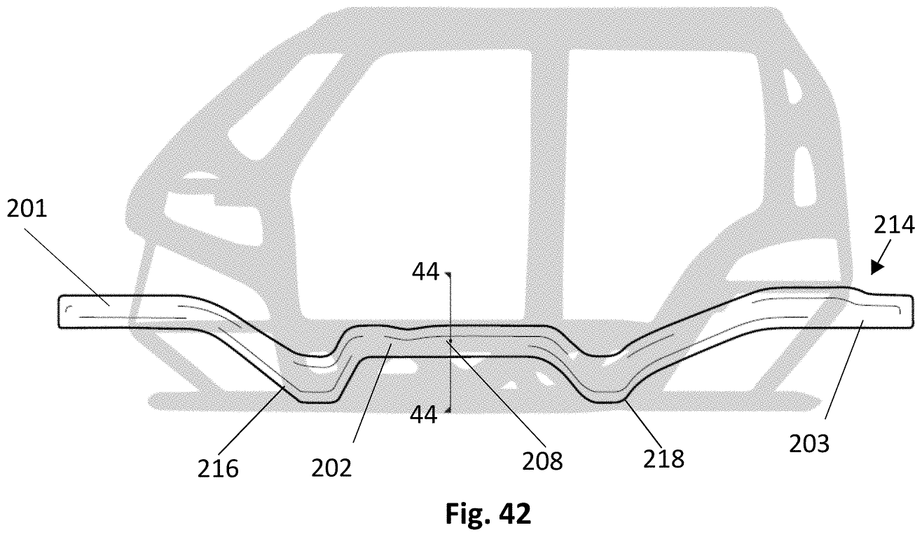

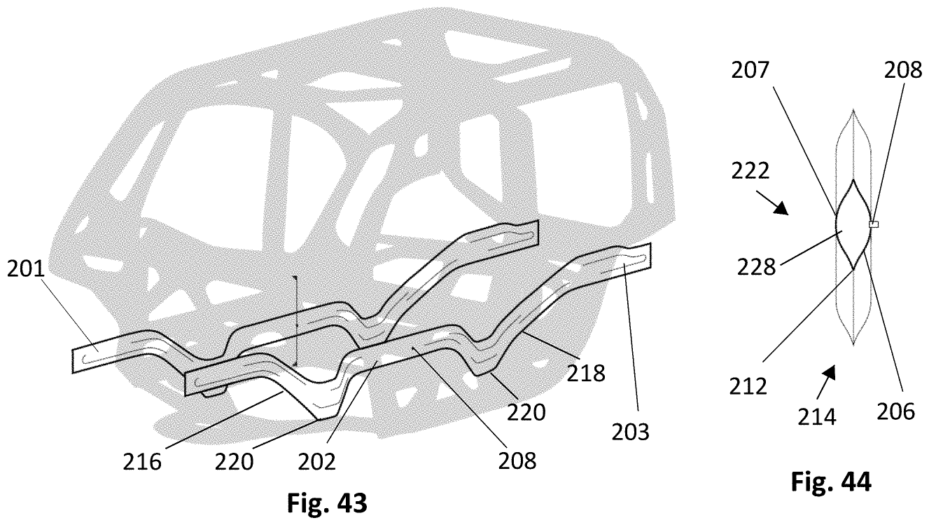

Exemplary arrangements of the frame components which strengthen vehicle structures and/or that provide other desirable properties may also be included in other vehicle structures. FIG. 40 shows a perspective view of a vehicle unibody frame which includes a pair of vehicle frame longitudinal members 214. The exemplary vehicle frame longitudinal members 214 each initially have the configuration of a preform which is shown in a side view in FIG. 41. FIGS. 42 and 43 show the exemplary vehicle frame longitudinal member integrated into the structure of the vehicle.

In the exemplary arrangement the vehicle frame longitudinal member 214 includes a front portion 201. The front portion 201 is configured to be directed from a central portion 202 toward the front of the vehicle. The exemplary central portion 202 is configured to be positioned in a central area of the vehicle. The exemplary vehicle frame longitudinal member 214 further includes a rear portion. The rear portion is configured to be directed from the central portion toward the rear of the vehicle. In the exemplary arrangement the central portion is configured to be positioned lower than the front portion and the rear portion when it is integrated in the vehicle structure.

In the exemplary arrangement of the vehicle frame longitudinal member 214 a transition region 216 is positioned intermediate of the front portion 201 and the central portion 202. The exemplary transition region includes a portion that is inclined in the bottom direction. In the exemplary arrangement a further transition region 218 is positioned intermediate of the central portion 202 and the rear portion 203. Second transition region 218 has a configuration that is similar to the inclined portion configuration of the transition region 216. The exemplary transition regions include lower protrusions 220. The exemplary lower protrusions 220 provide regions that extend to the lowest point on the vehicle frame longitudinal members when such members are in the operative position. In the exemplary arrangement the lower protrusions 220 serve the function of connecting members for connecting the floor member or other structures of the vehicle to the vehicle frame longitudinal members. Of course it should be understood that this configuration is exemplary and in other arrangements other approaches and configurations may be used.

FIG. 44 is a cross-sectional view along line 44-44 in FIG. 42. FIG. 44 shows the exemplary frame component of the vehicle frame longitudinal members. In this exemplary arrangement the frame component includes a first wall 206 comprised of at least one metal sheet and a second wall 207 which is comprised of at least one other metal sheet. In this exemplary arrangement the walls are comprised of a single steel sheet having a transverse thickness of 2 mm. Of course it should be understood that this configuration is exemplary and in other arrangements other configurations and transverse thicknesses may be used. For example in exemplary arrangements the sheets comprising the walls may have transverse thicknesses within a range of 1 mm to 5 mm. Of course it should be understood that in other arrangements other transverse thicknesses, numbers of sheets, sheet thicknesses in various regions, pressurizing fluids and other structures and materials may be used.

As shown in the exemplary arrangement of FIG. 44 the walls 206 and 207 are joined in hermetically sealed operative connection by seals generally indicated 212. The exemplary seals 212 may be formed in various ways including the ways that have been previously discussed herein. Similar to the other exemplary frame components this exemplary frame component designated 222 is configured such that the walls bound a sealed interior gap 228. Similar to the prior arrangements the exemplary sealed interior gap provides initially a closed empty inter space of the vehicle frame longitudinal member preform.

A fluid connector 208 is operative to enable the delivery of pressurized fluid into the hermetically sealed interior gap 228 of the frame component 222. The exemplary fluid connector enables leakproof fastening of a supply duct to the interior gap from a source of pressurized fluid. Further as discussed previously in connection with other exemplary frame components, the fluid connector may be in operative connection with a valve such as a check valve or pressure relief valve.

In the exemplary arrangement the outer edges of the walls 206, 207 are sealed and joined in hermetically sealed operative engagement by a seal 212. In exemplary arrangements the sealing is performed along the continuous circumferential edges of the walls and is accomplished by sealing methods such as circumferential welds or other joining methods of the types previously discussed. For example sealing may be accomplished by means of pressure welding, soldering, gluing, bending, pressing, wall forming or other joining methods. Further it should be understood that in other exemplary arrangements the walls 206, 207 of the frame component may be joined in operative connection through intermediate structures which are joined together with the walls to bound the hermetically sealed interior gap. It should be appreciated that numerous different structures and arrangements may be utilized to produce suitable frame components of the type described herein.

In exemplary methods of producing the vehicle frame longitudinal members, a source of pressurized fluid is connected to the fluid connector 208. In some exemplary arrangements the pressurized fluid comprises air delivered from a compressor or other suitable source of pneumatic pressure. Further it should be understood that in other exemplary arrangements the pressurized fluid may include fluids of the types previously discussed herein. These may include for example gases such as nitrogen containing gases or inert gases. Also in other exemplary arrangements the pressurized fluid may include water-based liquids, petroleum-based liquids, non-Newtonian fluids, foam, fluid cement, fluid concrete and fluid plastic polymers. Also in other exemplary arrangements the pressurized fluids may include flowable natural materials such as liquid rubber. Other exemplary arrangements may include materials that comprise one, two or three component foams such as a flex 140 type foam material. As previously discussed such pressurized fluid materials may be configured to be of a type that is released from the sealed interior gap after the preform is modified to the final configuration through the production method, or alternatively the fluid may remain within the sealed interior gap at the completion of the manufacturing process to provide desired properties. Further in exemplary arrangements the pressurized fluids may undergo changes in the form of curing or hardening after being delivered into the sealed interior gap to achieve other suitable properties such as those previously discussed.

In exemplary arrangements the delivery of the pressurized fluid into the sealed interior gap provides permanent deformation of the walls 206, 207 of the frame component 222. FIG. 44 shows the initial configuration of the walls prior to the application of the fluid pressure in solid lines. The configuration of the walls 206, 207 as shown in dotted lines indicates the configuration of the walls after undergoing permanent deformation as a result of the delivery of the fluid pressure. As can be appreciated in this exemplary arrangement the walls of the exemplary frame component are substantially deformed as a result the application of fluid pressure. Of course it should be understood that these approaches are exemplary and in other arrangements other approaches may be used.

In the exemplary vehicle frame longitudinal member 214 the structure has different geometrical dimensions in the front portion 201, the central portion 202 and the rear portion 203. These dimensions and configurations are selectively arranged to provide desired safety parameters in terms of both strength of the structure as well as providing areas for controlled deformation in the event of a collision. The exemplary arrangements also provide dimensions that are suitable for integrating the vehicle frame longitudinal members into the body structures of the particular vehicle.

In exemplary manufacturing methods of the vehicle frame longitudinal members 214 as shown, the manufacturing process is carried out at generally room temperature. However it should be understood that in alternative arrangements other manufacturing environments may be used. In exemplary arrangements the manufacturing processing parameters include processing the initial preform structure at a temperature of approximately 20° C. The fluid pressure that is applied to the sealed interior gap of the frame component is approximately 2 bars. In the exemplary arrangement the deformation time of the structure is approximately one minute which is required for pressure to be equalized in the structures of the frame component. The time associated with the delivery of the pressure within the sealed interior gap is 30 seconds and the total hold time during which deformation occurs is 1.5 minutes. Of course it should be understood that the structures of the vehicle frame longitudinal members and these production parameters are exemplary and in other arrangements other approaches may be used.

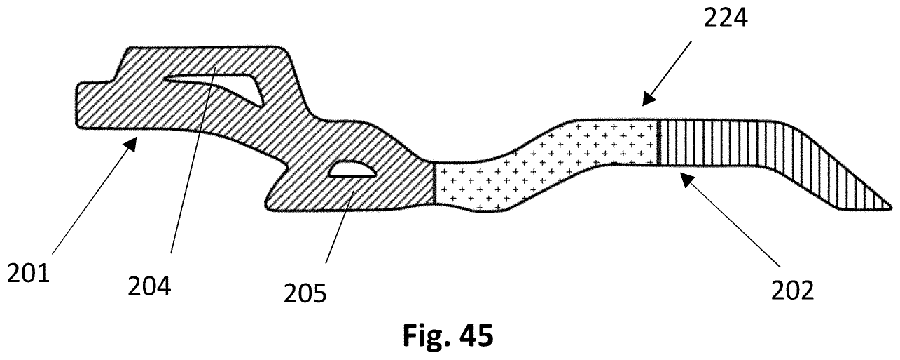

In exemplary arrangements vehicle frame longitudinal members that include frame components of exemplary arrangements, may also be made of different materials as well as materials having different transverse wall thicknesses. FIG. 45 shows a vehicle frame longitudinal member 224. Vehicle frame longitudinal member 224 is similar to vehicle frame longitudinal member 212 except as specifically described herein.

Vehicle frame longitudinal member 224 includes frame components that are manufactured of walls including metal sheets. However in this exemplary arrangement the metal sheets have different transverse cross-sectional thicknesses in different regions of the structure. The different transverse cross-sectional thicknesses in different regions form a patchwork type structure. As shown in FIG. 45 the exemplary member 224 includes three different regions. Each of the regions is designated by different section lines. In the exemplary arrangement the walls of the frame components in the vehicle frame longitudinal member are comprised of stainless steel sheets of different thicknesses. In this exemplary arrangement a region shown with diagonal lines has a cross-sectional thickness of 2 mm. This region includes a front portion 201 and a transition portion that extends between the front portion 201 and a central portion 202. A region having a second thickness of 1.5 mm indicated as a dotted area includes a front fragment of the central portion 202. A third region having a thickness of 1.2 mm is indicated with vertical lines. This region includes a rear fragment of the central portion 202.

In this exemplary arrangement the inner wall 206 and the outer wall 207 are comprised of metal sheets which have varying thicknesses between the individual regions of the vehicle frame longitudinal member 224. As a result of the patchwork type structure the vehicle frame member produced through the exemplary manufacturing methods achieved as a result of the frame components integrated therewith desired functional characteristics of increased strength and rigidity in the regions having the increased sheet thickness. In the exemplary arrangement the structure of the first wall 206 and the second wall 207 is an integrated structure including regions of smaller and greater thicknesses of the respective sheets which comprise the walls. In exemplary arrangements the different thicknesses of the walls in the different respective regions is achieved through wall formation processes which provide different thicknesses such as press forming, rolling, joining of multiple overlying sheets having different thicknesses, and other processes for providing varied transverse wall thicknesses.

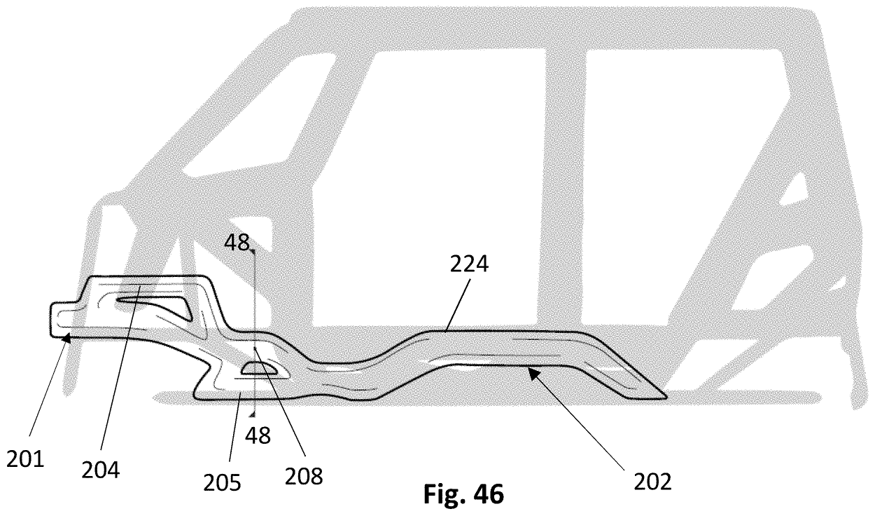

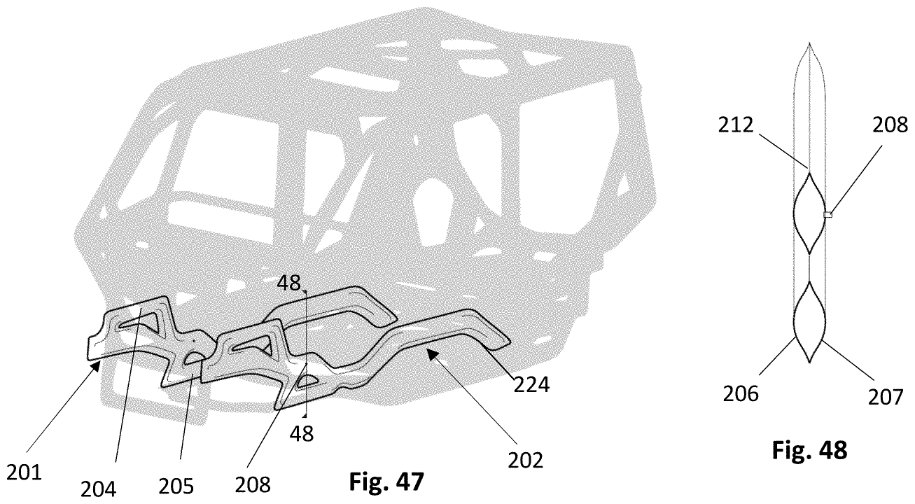

FIGS. 46 and 47 show the exemplary vehicle frame longitudinal members 224 integrated into a vehicle frame structure. The exemplary members do not include a rear portion that extends toward the rear of the vehicle from the central portion. As shown in this exemplary arrangement the rear of the vehicle may include other structures that provide the suitable properties of the vehicle rearward of the central portion.

Further the exemplary vehicle frame longitudinal member 224 includes an annular structure 204. The exemplary annular structure 204 provides thereon connecting surfaces for connecting to other members of the vehicle. Further the exemplary annular structure 204 provides increased strength and stability in the region in which the annular structure is located. In the exemplary arrangement the annular structure helps to withstand deformations resulting from impacts at the front of the vehicle. However it should be understood that this arrangement is exemplary and in other arrangements other structures similar to annular structures 204 may be provided without an opening to provide increased strength and rigidity. In exemplary arrangements annular structures may be provided for purposes of achieving reduced weight or other properties in the area of the front portion 201 in which the annular structure 204 is located.

Further in the exemplary arrangement the vehicle frame longitudinal member 224 further includes an annular transition structure 205. In this exemplary arrangement the annular transition structure is positioned between the front portion 201 and the central portion 202. The exemplary annular transition structure 205 serves to provide connection surfaces for connecting vehicle floor members. Further in exemplary arrangements the transition structure 205 may serve to provide increased strength and stability of the vehicle frame longitudinal member. Further in some arrangements the annular transition structure may provide reduced mass of the longitudinal member. Of course it should be understood that these approaches are exemplary and in other arrangements other approaches may be used.

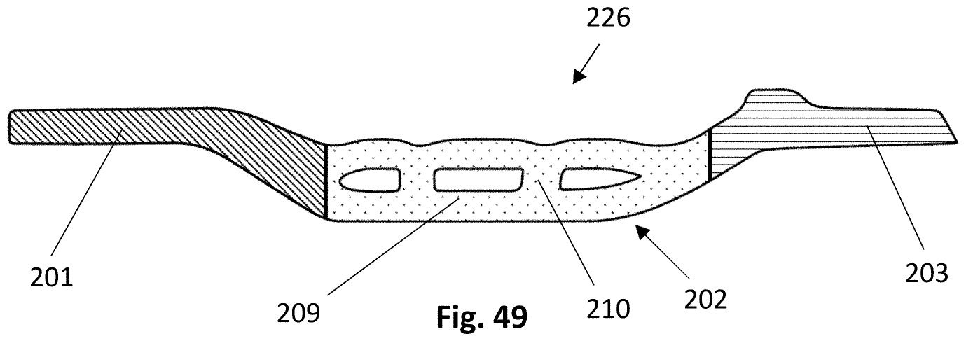

FIGS. 49-51 show a further exemplary vehicle frame longitudinal member 226. This exemplary vehicle frame longitudinal member is generally similar to the vehicle frame longitudinal members previously discussed and is manufactured using similar methods except as otherwise indicated herein.

Vehicle frame longitudinal member 226 includes a central portion 202 that includes a central annular structure 209. In the exemplary arrangement the central annular structure 209 includes a pair of longitudinally disposed reinforcing ribs 210. The exemplary ribs 210 extend in an opening defined by the central annular structure and serve to operatively connect the opposed longitudinal regions of the exemplary central annular structure.

The exemplary configuration of the vehicle frame longitudinal member 226 and particularly the number and configuration of the central annular structure 209 and reinforcing ribs 210 may have various configurations in different arrangements. Further it should be understood that the reinforcing ribs in some arrangements may be initially manufactured as independent structures that are joined in operative fixed connection with the vehicle frame longitudinal members. Numerous different connecting methods may be utilized for operatively connecting the reinforcing ribs 210 within the central annular structure 209. As can be appreciated joining methods such as welding, bolting, crimping, gluing or other fastening methods may be utilized for joining the reinforcing ribs and the longitudinal member structures.

Further it should be understood that in exemplary arrangements where the reinforcing ribs are initially produced as separate structures that are joined in fixed connection with the vehicle frame longitudinal member central portion 209, one or more of the respective reinforcing ribs, may include frame components of the exemplary arrangements which provide increased strength thereof. In such arrangements the ribs may include a first wall and a second wall that bound a sealed interior gap into which pressurized fluid is introduced through a fluid connector in a manner like that previously discussed. Of course it should be understood that these approaches are exemplary and in other arrangements other approaches may be used.

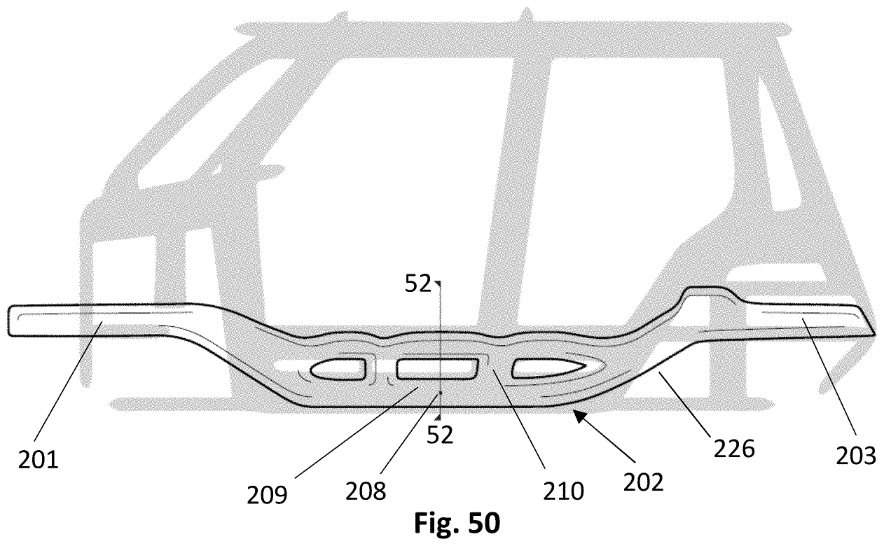

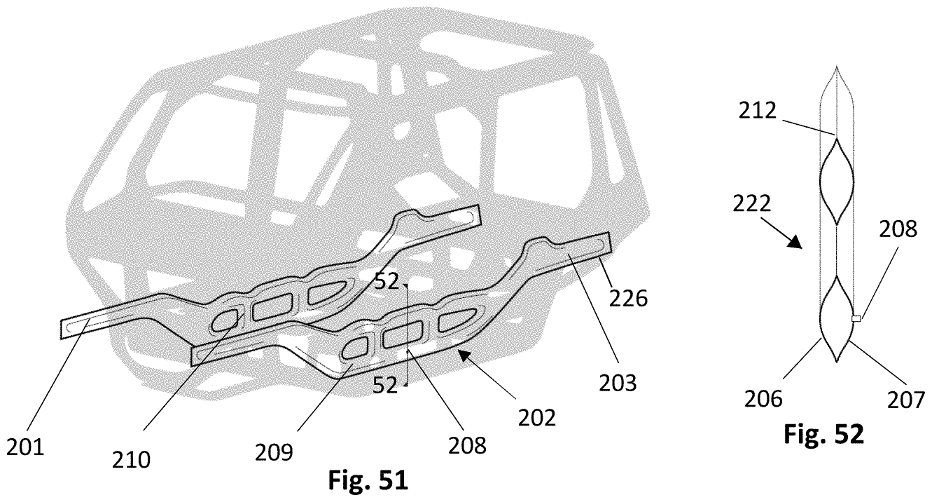

As shown in FIGS. 50 and 51 the exemplary vehicle frame longitudinal member 226 may be integrated into a vehicle structure as shown with a front portion 201 thereof extending from the central portion 202 toward the front of the vehicle and with a rear portion 203 extending from the central portion toward the rear of the vehicle. The exemplary central portion 202 in the operative position extends lower than the front and rear portions.

As represented in FIG. 49 the exemplary vehicle frame longitudinal member 226 has different regions comprised of different materials. In the exemplary arrangement the member is comprised of a first material indicated by diagonal lines which is comprised of stainless steel sheet. This region extends in the front portion 201 and the forward area of the central portion 202. In this exemplary arrangement the central portion 202 which is shown in a dotted configuration is comprised of carbon steel sheet. A third region which extends in a rearward portion of the central portion 202 and which includes the rear portion 203, and which is indicated with horizontal lines, is comprised of black steel sheet. As shown these regions provide a material patchwork type structure.

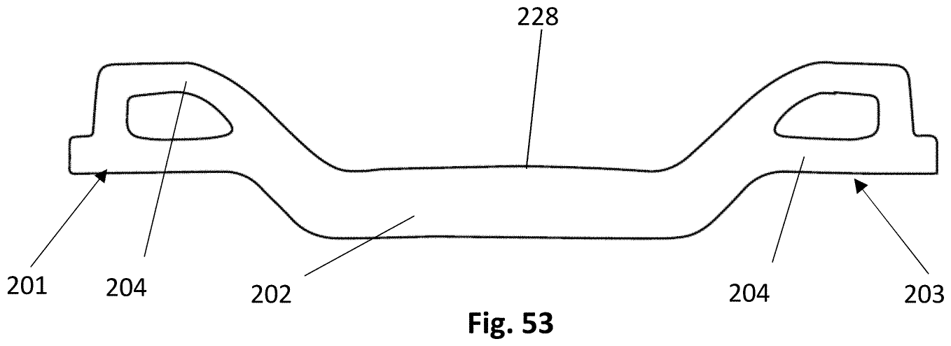

A cross-sectional view of the central portion taken along lines 52-52 in FIGS. 50 and 51 is shown in FIG. 52. In this exemplary arrangement which shows the exemplary frame component, the bounding walls 206, 207 are joined in operatively sealed connection so as to provide the hermetically sealed interior gap as in other exemplary arrangements. Pressurized fluid that is delivered through the fluid connector 208 causes the permanent deformation of the walls from the initial configuration that is shown in solid lines to the final configuration that is shown in dashed lines in FIG. 52.

Because in this exemplary arrangement the walls 206, 207 are comprised of metal sheets of varying materials the exemplary vehicle frame longitudinal member is provided with desirable functional characteristics. These include increased strength in the form of higher rigidity in the regions in which the walls of the frame components are comprised of materials which have such properties. As can be appreciated in the exemplary arrangements the different materials of the different regions are joined in permanently engaged connection through suitable joining methods of the types previously discussed. Further in exemplary arrangements in which the pressurized fluid that is introduced into the sealed interior gap remains within the frame component after manufacture is completed, additional advantageous properties may be achieved for the vehicle frame longitudinal members. Suitable pressurized fluids for achieving different properties may also be of the types that have been previously discussed herein in connection with other vehicle structures.

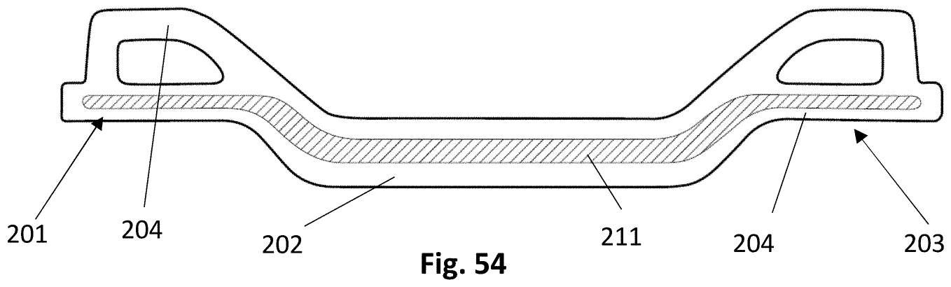

A further exemplary vehicle frame longitudinal member 228 is shown in FIGS. 53-57. This exemplary vehicle frame longitudinal member 228 is similar to the vehicle frame longitudinal members previously described except as otherwise indicated.

Vehicle frame longitudinal member 228 includes a central portion 202, a front portion 201 and a rear portion 203. A front end annular structure 204 is located in the front portion 201. A rear end annular structure 204 is positioned in the rear portion 203. In the exemplary arrangement a purpose of the end annular structures 204 is to provide connection surfaces for connecting to members of the vehicle as well as for providing increased strength and stability. Further in exemplary arrangements the annular structures with the openings therein provide reduced weight compared to exemplary arrangements which may use solid end structures.

In the exemplary arrangement frame longitudinal member 228 has flattened regions 211 on the inner wall 206 and the outer wall 207 of the frame component that is integrated in the respective member. In the exemplary arrangements the flattened regions have a substantially flat surface. The flattened regions enable adjustment of the technical parameters and properties of the frame longitudinal members. The flattened regions also provide mounting regions for equipment of the vehicle. The exemplary arrangement of the vehicle frame longitudinal member 228 is configured particularly to reduce the width dimension of the member compared to conventional structures while providing improved properties.

The exemplary flattened regions 211 are formed using methods like those previously discussed. This includes placing the vehicle frame longitudinal member preform within an area bounded by pressure plates 213 (such as is shown in FIG. 4) while the pressurized fluid is introduced into the sealed interior gap between the walls 206, 207. As discussed in connection with other exemplary arrangements the pressure plates may be the working elements of a mechanical press. In exemplary arrangements, controlled force may be applied to the pressure plates 213 in a direction toward the walls of the vehicle longitudinal member frame component that is being deformed by the delivery of pressurized fluid. In exemplary arrangements the deformation of the walls is limited by the engagement with the pressure plates to produce the flattened regions 211. Further as can be appreciated exemplary arrangements of the vehicle frame components may include additional structures and configurations to achieve desirable properties.

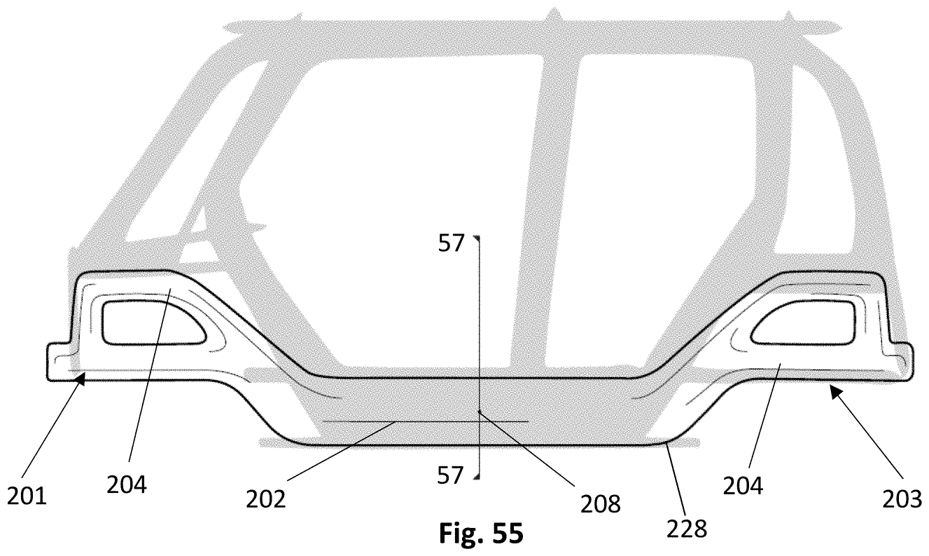

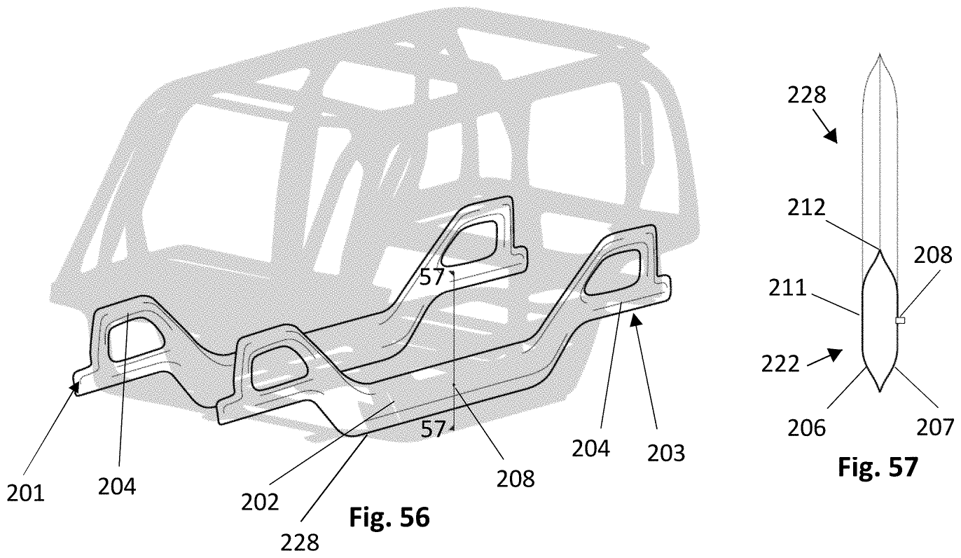

FIG. 57 shows a cross-sectional view of the vehicle frame longitudinal member 228 taken along lines 57-57 in FIGS. 55 and 56. The region deformed through the action of the pressurized fluid and the pressure plates 213 includes the flattened regions 211 shown in dotted lines. Solid lines represent the original dimensions of the frame component 222 prior to the application of the pressurized fluid.

The exemplary manufacturing method which is utilized in producing the structure illustrated in FIG. 57 is accomplished using an arrangement such as schematically shown in FIG. 5. In this exemplary arrangement one vehicle frame longitudinal member portion is not in contact with the pressure plates and the walls of the frame component may be deformed in a free manner, while another portion of the vehicle frame longitudinal member is in contacting engagement with the pressure plates. In this exemplary arrangement it is possible to provide precisely the configurations and structures for the particular desired properties. This may include for example strengthening properties which provide the desired characteristics of rigidity in areas of the member, as well as controlled deformation zones. In addition the configurations also provide suitable mounting locations and support areas for engagement with the vehicle frame longitudinal member.

Of course it should be understood that these configurations are exemplary and in other arrangements other approaches may be used.

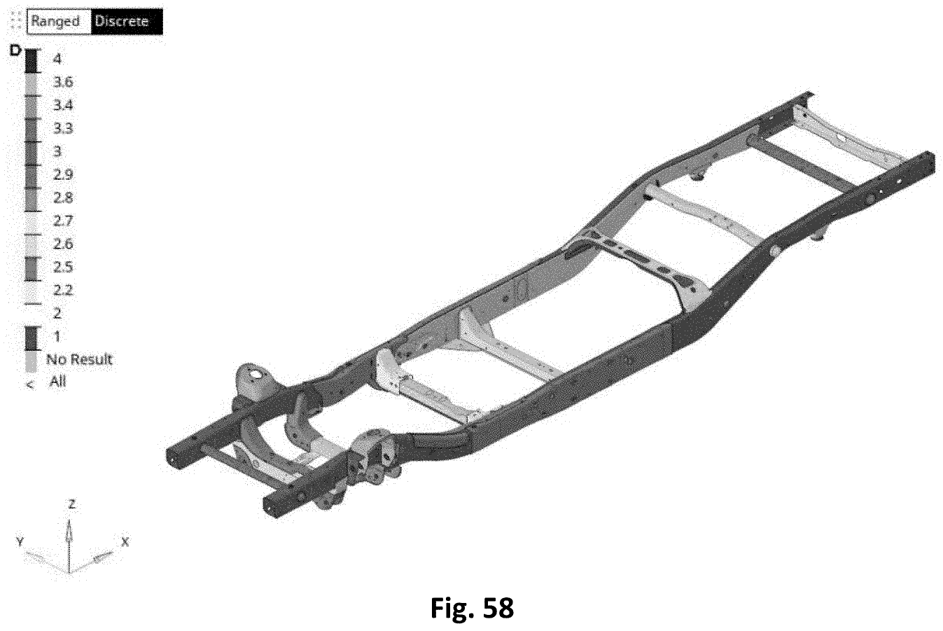

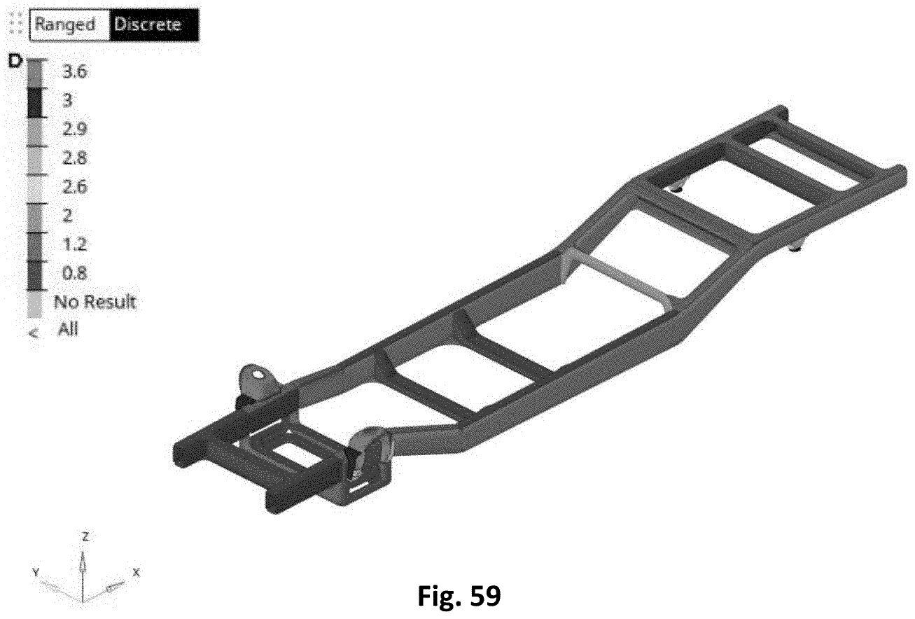

The vehicle frame longitudinal members manufactured using the exemplary methods and produced in accordance with the exemplary arrangements described herein were subjected to comparative tests based with a vehicle frame longitudinal member manufactured using known prior art technology. For the purpose of performing the comparative tests, a frame structure comprising frame longitudinal members of a Chevrolet® Silverado® 1500 (2014 model year) was selected. A model of the vehicle frame based on the Chevrolet Silverado 1500 frame longitudinal members manufactured in accordance with prior art technology is shown in FIG. 58. A corresponding vehicle frame comprised of vehicle frame longitudinal members of exemplary arrangements described herein is shown in FIG. 59.

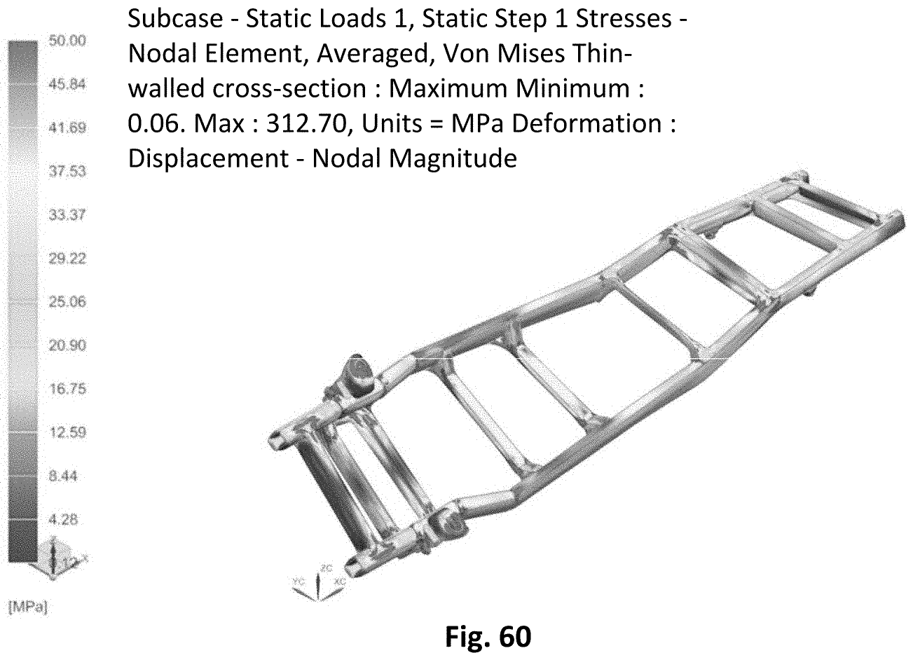

FIG. 60 shows a stress distribution map for the structure produced as a result of torsional testing of the frame model in FIG. 59. Identical boundary conditions were imposed for all the testing models. The applied values of rotation in twisting corresponded to the loading with a twisting moment of M=100 Nm. The material used in the simulations was steel having a Young's Modulus E equals 206.94 Gpa., Poisson's ratio v=0.288 and density p=7829 kg/m³. The individual component members of the frame based on the frame longitudinal members in accordance with the exemplary arrangements included walls comprised of a metal sheet having a thickness of from 0.8 mm to 2 millimeters.

The calculated strength parameters are presented in Table 4 below.

TABLE 4
Comparison of the strength parameters of the vehicle frame
manufactured from the vehicle frame longitudinal members

| | | |
|---|---|---|
| frame based | Number of component | 62 |
| on frame | members | |
| longitudinal members | Torsional rigidity [Nm/°] | 3.13 |
| of prior art technology | Mass [kg] | 200 |
| | Light Weight Index | 17.51 |
| frame based | Number of component | 74 (including 58 of the |
| on frame | members | invention) |
| longitudinal members of | Torsional rigidity [Nm/°] | 3.46 |
| exemplary arrangements | Mass [kg] | 186.4 |
| | Light Weight Index | 14.48 |

As shown in Table 4 the frame made in accordance with the exemplary arrangements discussed herein is lighter in weight than the conventional frame while showing more favorable torsional rigidity. In the case of the prior art technology the frame was constructed from 62 component members, while the frame made from the exemplary arrangements discussed herein was constructed from 74 component members, 58 of which were members manufactured produced by introducing fluid under pressure into the sealed interior gap between the walls comprised of sheet metal to achieve permanent deformation to produce the final wall configurations.

The Light Weight Index (LWI) parameter shown in Table 4 is a parameter known to persons of skill in the art for comparison purposes and defines the structural efficiency of a structure. Its lower value indicates that a more favorable structural efficiency was obtained. The LWI parameter referred to herein was defined for example in the publication of Singh, Harry dated August 2012 entitled Mass Reduction for Light-Duty Vehicles for Model Years 2017-2025 (Report No. DOT HS 811 666).

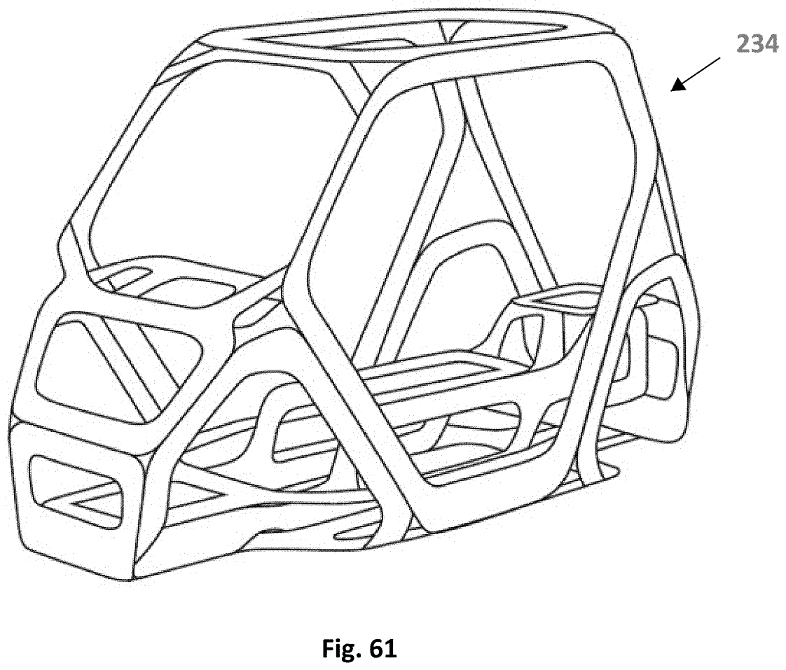

FIG. 61 shows a perspective view of an exemplary vehicle body frame 234. The exemplary vehicle body frame includes vehicle structures that incorporate the exemplary frame components of the types previously discussed. In this exemplary arrangement the vehicle body frame 234 includes two vehicle side frames such as the one shown in FIG. 2. Two vehicle floor members of the types shown in FIGS. 19 and 20 provide the floor system of the exemplary vehicle body frame 234. Further a pair of vehicle frame longitudinal members of the type shown in FIG. 32 are integrated in the vehicle body frame structure. Of course it should be understood that other exemplary arrangements may include lesser or greater numbers of vehicle structures that incorporate the exemplary frame components that have been described herein to provide desired increased strength and other properties.

Thus the exemplary arrangements achieve improved capabilities, have desirable properties and eliminate difficulties encountered in the use of prior vehicle frame arrangements and attain the useful results described herein.

In the foregoing description, certain terms have been used for brevity, clarity and understanding. However, no unnecessary limitations are to be implied therefrom because such terms are used for descriptive purposes and are intended to be broadly construed. Moreover the descriptions and illustrations herein are by way of examples and the new and useful features and methods are not limited to the exact features and methods shown and described.

It should further be understood that the features and/or relationships associated with one exemplary arrangement can be combined with features and/or relationships from another exemplary arrangement. That is, various features and/or relationships from various arrangements can be combined together to form further arrangements. The new and useful scope of the disclosure is not limited only to the exemplary arrangements that have been shown and described.

Having described features, discoveries and principles of the exemplary arrangements, the manner in which they are constructed, produced and operated, and the advantages and useful results attained, the new and useful features, devices, elements, arrangements, parts, combinations, systems, equipment, operations, methods, processes and relationships are set forth in the appended claims.

I claim:

1. Apparatus comprising:
a frame component configured to be integrated in a vehicle structure, including:
a first wall, wherein the first wall is comprised of metal sheet,
a second wall, wherein the second wall is comprised of metal sheet,
wherein the second wall
includes a portion that is disposed away from the first wall, and
is in hermetically sealed operative connection with the first wall,
wherein a sealed interior gap extends between the first wall and the second wall,
a fluid connector,
wherein the fluid connector
is configured to deliver pressurized fluid received through the connector into the gap through one of the first wall in the second wall,
wherein the delivered fluid is operative to increase strength of the frame component.

2. The apparatus according to claim 1
wherein at least one of the first wall and the second wall is permanently deformed responsive to the delivered fluid.

3. The apparatus according to claim 1
the frame component further including:
a hermetically sealed pocket within the interior gap.

4. The apparatus according to claim 1
the frame component further including:
a hermetically sealed pocket within the interior gap,
wherein the pocket has a pocket interior area,
wherein the fluid connector is configured to deliver the fluid into the pocket interior area.

5. The apparatus according to claim 1
the frame component further including:
a hermetically sealed pocket within the interior gap,
wherein the pocket has a pocket interior area bounded by a pocket wall,
wherein the fluid connector is configured to deliver the fluid into the pocket interior area,
wherein the pocket wall is permanently deformed responsive to the delivered fluid.

6. The apparatus according to claim 1
wherein the fluid connector is in operative connection with a check valve,
wherein the check valve is configured to prevent fluid flow out of the gap.

7. The apparatus according to claim 1
wherein one of the first wall and the second wall includes a plurality of different regions,
wherein the one of the first wall and the second wall has a respective transverse wall thickness in each of the respective regions,
wherein a respective first transverse wall thickness in a first region differs from a respective second transverse wall thickness in a second region.

8. The apparatus according to claim 1
wherein the first wall includes a plurality of first wall regions,
wherein each respective first wall region has a respective first wall transverse thickness,
wherein a respective first wall transverse thickness in one first wall region differs from a respective first wall transverse thickness in another first wall region that is disposed away from the one first wall region,
wherein the second wall includes a plurality of second wall regions,
wherein each respective second wall region has a respective second wall transverse thickness,
wherein a respective second wall transverse thickness in one second wall region differs from a respective second wall transverse thickness in another second wall region that is disposed away from the one second wall region.

9. The apparatus according to claim 1
wherein at least one of the first wall and the second wall includes a permanently deformed flattened outer surface responsive to the delivered fluid and an external adjacent pressure plate.

10. The apparatus according to claim 1
wherein the delivered fluid comprises at least one of
air,
nitrogen containing gas,
inert gas,
water based liquid,
petroleum based liquid,
non-Newtonian fluid,
flowable natural material,
foam,
fluid cement,
fluid concrete, and
fluid plastic polymer.

11. The apparatus according to claim 1
and further comprising:
at least one vehicle structure, wherein the at least one vehicle structure includes the frame component,
wherein the at least one vehicle structure includes at least one of
a vehicle side frame,
a vehicle floor member, and
a vehicle frame longitudinal member.

12. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle side frame includes the frame component,
wherein the vehicle side frame includes
a roof portion
a front pillar portion,
a rear pillar portion, and
a sill portion,
each of which operatively bound a vehicle access opening.

13. The apparatus according to claim 1
and further comprising:
at least one vehicle structure, wherein the at least one vehicle structure includes at least one of
a vehicle side frame,
a vehicle floor member, and
a vehicle frame longitudinal member,
wherein the vehicle side frame includes the frame component,
wherein the vehicle side frame includes
a roof portion,
a front pillar portion,
a rear pillar portion,
a sill portion, and
a central pillar portion, wherein the central pillar portion extends intermediate of the front pillar portion and the rear pillar portion, and extends in operative engaged relation between the roof portion and the sill portion.

14. The apparatus according to claim 1
and further comprising:
at least one vehicle structure, wherein the at least one vehicle structure includes at least one of
a vehicle side frame,
a vehicle floor member, and
a vehicle frame longitudinal member,
wherein the vehicle side frame includes a vehicle access opening operatively bounded by
a roof portion,
a front pillar portion,
a rear pillar portion,
a sill portion, and
a central pillar portion, wherein the central pillar portion extends intermediate of the front pillar portion and the rear pillar portion, and extends in operative engaged relation between the roof portion and the sill portion,
wherein the central pillar portion includes the frame component.

15. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle floor member includes the frame component, wherein the vehicle floor member includes
a front frame portion,
a rear frame portion,
a pair of side frame portions, wherein each of the side frame portions extends intermediate of the front frame portion and the rear frame portion,
a front bumper portion that extends from the front frame portion, and
a rear bumper portion that extends from the rear frame portion.

16. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle floor member includes the frame component, wherein the vehicle floor member includes
a front frame portion,
a rear frame portion,
a pair of side frame portions, wherein each of the side frame portions extends intermediate of the front frame portion and the rear frame portion,
a frame longitudinal rib, wherein the frame longitudinal rib extends transversely intermediate of the frame side portions and extends in operative engagement with each of the front frame portion and the rear frame portion,
a front bumper portion that extends from the front frame portion, and
a rear bumper portion that extends from the rear frame portion.

17. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle floor member includes the frame component, wherein the vehicle floor member includes
a front frame portion,
a rear frame portion,
a pair of side frame portions, wherein each of the side frame portions extends intermediate of the front frame portion and the rear frame portion,
a frame transverse rib, wherein the frame transverse rib extends intermediate of the front frame portion and the rear frame portion and extends in operative engagement with each of the side frame portions,
a front bumper portion that extends from the front frame portion, and
a rear bumper portion that extends from the rear frame portion.

18. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle floor member includes the frame component, wherein the vehicle floor member includes
an annular front frame portion,
an annular rear frame portion,
a pair of annular side frame portions, wherein each of the side frame portions extends intermediate of the front frame portion and the rear frame portion,
an annular front bumper portion that extends from the front frame portion, and
an annular rear bumper portion that extends from the rear frame portion.

19. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle floor member includes the frame component, wherein the vehicle floor member includes
a front frame portion,
a rear frame portion,
a pair of side frame portions, wherein each of the side frame portions extends intermediate of the front frame portion and the rear frame portion,
a front bumper portion that extends from the front frame portion, and
a rear bumper portion that extends from the rear frame portion,
wherein at least one of the front frame portion and the rear frame portion comprises an annular frame portion,
and further including:
a reinforcing pillar, wherein the reinforcing pillar extends across the annular frame portion.

20. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle floor member includes the frame component, wherein the vehicle floor member includes
a front frame portion,
a rear frame portion,
a pair of side frame portions, wherein each of the side frame portions extends intermediate of the front frame portion and the rear frame portion,
a front bumper portion that extends from the front frame portion, and
a rear bumper portion that extends from the rear frame portion,
and further comprising:
a further vehicle floor member in fixed stacked operative engagement with the vehicle floor member,
wherein the further vehicle floor member includes
a further front frame portion,
a further rear frame portion,
a pair of further side frame portions, wherein each of the further side frame portions extends intermediate of the further front frame portion and the further rear frame portion,
a further front bumper portion that extends from the front portion,
a further bumper rear portion that extends from the rear portion.

21. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle frame longitudinal member includes the frame component, wherein the vehicle frame longitudinal member includes
a central portion configured to be positioned in a central area of a vehicle, and
a front portion, wherein the front portion is configured to be directed from the central portion toward a front of the vehicle.

22. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle frame longitudinal member includes the frame component, wherein the vehicle frame longitudinal member includes
a central portion configured to be positioned in a central area of a vehicle,
a front portion, wherein the front portion is configured to be directed from the central portion toward a front of the vehicle, and
a rear portion configured to be directed from the central portion toward a rear of the vehicle.

23. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle frame longitudinal member includes the frame component, wherein the vehicle frame longitudinal member includes
a central portion configured to be positioned in a central area of a vehicle,
a front portion, wherein the front portion is configured to be directed from the central portion toward a front of the vehicle, and
a rear portion configured to be directed from the central portion toward a rear of the vehicle,
wherein the central portion is configured to be extend lower in the vehicle than each of the front portion and the rear portion.

24. The apparatus according to claim 1
and further comprising:
at least one vehicle structure,
wherein the at least one vehicle structure includes at least one of
a vehicle side frame,
a vehicle floor member, and
a vehicle frame longitudinal member,
wherein the vehicle frame longitudinal member includes the frame component, wherein the vehicle frame longitudinal member includes
a central portion configured to be positioned in a central area of a vehicle,
a front portion, wherein the front portion is configured to be directed from the central portion toward a front of the vehicle, and
a rear portion configured to be directed from the central portion toward a rear of the vehicle,
at least one annular transition portion, wherein the at least one annular transition portion is positioned intermediate of the central portion and at least one of the front portion and the rear portion.

25. The apparatus according to claim 1
and further comprising:
at least one vehicle structure,
wherein the at least one vehicle structure includes at least two of
a vehicle side frame,
a vehicle floor member, and
a vehicle frame longitudinal member,
wherein each of the at least two of the vehicle side frame, the vehicle floor member, and the vehicle frame longitudinal member includes a respective frame component.

26. The apparatus according to claim 1
and further comprising:
at least one vehicle structure,
wherein the at least one vehicle structure includes each of
a vehicle side frame,
a vehicle floor member, and
a vehicle frame longitudinal member,
wherein each of the of the vehicle side frame, the vehicle floor member, and the vehicle frame longitudinal member includes a respective frame component.

27. Apparatus comprising:
a frame component configured to be integrated in a vehicle structure, including:
a first wall comprised of at least one metal sheet,
a second wall comprised of at least one further metal sheet,
wherein the first wall and the second wall bound a hermetically sealed interior gap, wherein the interior gap extends between the walls,
a fluid connector,
wherein the fluid connector is configured to deliver pressurized fluid through one of the first wall and the second wall and into the interior gap,
wherein the delivered fluid is operative to increase strength of the frame component.

28. The apparatus according to claim 27
wherein at least one of
the at least one metal sheet, and
the at least one further metal sheet
it is permanently deformed responsive to the delivered fluid.

29. The apparatus according to claim 27
wherein the frame component further includes:
a hermetically sealed pocket within the interior gap,
wherein the pocket bounds a pocket interior area,
wherein the delivered fluid is received in the pocket interior area.

30. The apparatus according to 27
wherein the frame component further includes:
a hermetically sealed pocket within the interior gap,
wherein the pocket includes a pocket wall that bounds a pocket interior area,
wherein the delivered fluid is received to the pocket interior area,
wherein the pocket wall is permanently deformed responsive to the fluid.

31. The apparatus according to claim 27
wherein at least one of
the at least one metal sheet, and
the at least one further metal sheet,
has a nonuniform transverse wall thickness.

32. A method comprising:
a) joining in engaged relation
a first wall comprising at least one metal sheet and
a second wall comprising at least one further metal sheet
of a frame component configured to be integrated in a vehicle structure such that the first wall and the second wall bound a hermetically sealed interior gap between the walls,
b) delivering via a fixed connector, pressurized fluid into the interior gap through the first wall or the second wall, wherein the delivered fluid is operative to increase strength of the frame component.

33. The method according to claim 32
wherein in (b) at least one of the first wall and the second wall are permanently deformed responsive to the delivered fluid.

34. The method according to claim 32
wherein in (a) the first wall and the second wall are joined with a hermetically sealed pocket extending in the interior gap,
wherein in (b) the fluid is delivered into a pocket interior area of the pocket.

35. The method according to claim 32
wherein in (a) the first wall and the second wall are joined with a hermetically sealed pocket extending in the interior gap,
wherein in (b) the fluid is delivered into a pocket interior area of the pocket and at least one pocket wall bounding the pocket is permanently deformed responsive to the delivered fluid.

36. The method according to claim 32 and further comprising:
subsequent to (b) integrating the frame component in the vehicle structure with the fluid remaining within the hermetically sealed interior gap.
